(19) United States
(12) Patent Application Publication
(10) Pub. No.: US 2025/0298638 A1
(43) Pub. Date: Sep. 25, 2025

(54) PERSONALIZATION OF USER INTERFACE TEMPLATES

(71) Applicant: Roku, Inc., San Jose, CA (US)

(72) Inventors: Ronica Jethwa, Mountain View, CA (US); Abhishek Bambha, San Jose, CA (US); Rohit Mahto, San Jose, CA (US); Fei Xiao, San Jose, CA (US); Daniel Meropol, New York, NY (US); Hrvoje Torbasinovic, San Mateo, CA (US); Apoorv Bansal, San Jose, CA (US); Jeffrey Tang, Irvine, CA (US)

(21) Appl. No.: 18/611,562

(22) Filed: Mar. 20, 2024

(51) Int. Cl. G06F 9/451; G06F 11/34; G06F 16/904

(52) U.S. Cl. CPC G06F 9/451; G06F 11/3438; G06F 16/904

(57) ABSTRACT

Disclosed herein are computing system, apparatus, article of manufacture, method and/or computer program product embodiments, and/or combinations and sub-combinations and sub-combinations thereof, for generating customized/personalized content browser UIs and browsing experiences. For example, a computing system may be configured to obtain data about one or more user interactions with a content browser user interface (UI). In some cases, the content browser UI displays a plurality of groups of tiles representing different content items. Additionally, the computing system may be configured to identify, based on the data about the one or more user interactions, a first template specifying a layout of the content browser UI and a second template specifying a configuration of one or more groups of tiles of the plurality of groups of tiles. Further, the computing system may be configured to update the content browser UI based on the second template.

### BACKGROUND

### Field

This disclosure is generally directed to user interface (UI) generation, and more particularly to generating UI templates based on user interaction data.

### SUMMARY

Provided herein are system, apparatus, article of manufacture, method and/or computer program product embodiments, and/or combinations and sub-combinations thereof, for generating customized/personalized content browser UIs and browsing experiences.

In some aspects, a computing system is provided for generating customized/personalized content browser UIs and browsing experiences. The computing system may include a memory storing instructions and at least one processor coupled to the memory. The at least one processor may be configured to execute the instructions to obtain data about one or more user interactions with a content browser user interface (UI). In some instances, the content browser UI displays a plurality of groups of tiles representing different content items. Additionally, the at least one processor may be configured to identify, based on the data about the one or more user interactions, a first template specifying a layout of the content browser UI and a second template specifying a configuration of one or more groups of tiles of the plurality of groups of tiles. Further, at least one processor may be configured to update the content browser UI based on the second template.

In other aspects, a computer-implemented method is provided for generating customized/personalized content browser UIs and browsing experiences. The computer-implemented method may include obtaining data about one or more user interactions with a content browser user interface (UI). In some instances, the content browser UI displays a plurality of groups of tiles representing different content items. Additionally, the computer-implemented method may include identifying, based on the data about the one or more user interactions, a first template specifying a layout of the content browser UI and a second template specifying a configuration of one or more groups of tiles of the plurality of groups of tiles. Further, the computer-implemented method may include updating the content browser UI based on the second template.

In various aspects a non-transitory computer-readable medium is provided for generating customized/personalized content browser UIs and browsing experiences. The non-transitory computer-readable medium may store instructions that, when executed by at least one processor, cause the at least one processor to perform operations comprising obtaining data about one or more user interactions with a content browser user interface (UI). In some instances, the content browser UI displays a plurality of groups of tiles representing different content items. Additionally, the operations may include identifying, based on the data about the one or more user interactions, a first template specifying a layout of the content browser UI and a second template specifying a configuration of one or more groups of tiles of the plurality of groups of tiles. Further, the operations may include updating the content browser UI based on the second template.

### BRIEF DESCRIPTION OF THE FIGURES

The accompanying drawings are incorporated herein and form a part of the specification.

FIG. 1 illustrates a block diagram of a multimedia environment, according to some examples of the present disclosure;

FIG. 2 illustrates a block diagram of a streaming media device, according to some examples of the present disclosure;

FIG. 3 illustrates a diagram of a portion of the multimedia environment, according to some examples of the present disclosure;

FIG. 4 illustrates a block diagram for customizing/personalizing a content browser user interface (UI), according to some examples of the present disclosure;

FIG. 5 illustrates an example content browser UI and group templates, according to some examples of the present disclosure;

FIG. 6 illustrates a diagram of a portion of the multimedia environment, according to some examples of the present disclosure;

FIG. 7 illustrates a flow chart of an example process for obtaining a content browser UI including one or more templates, according to some examples of the present disclosure;

FIG. 8 illustrates a flow chart of an example process for providing content browser UI to a media device, according to some examples of the present disclosure;

FIG. 9 illustrates a flow chart of an example process for determining one or more templates for a content browser UI, according to some examples of the present disclosure;

FIG. 10 is a diagram illustrating an example of a neural network architecture, according to some examples of the present disclosure; and

FIG. 11 illustrates an example computer system that can be used for implementing various aspects of the present disclosure.

In the drawings, like reference numbers generally indicate identical or similar elements. Additionally, generally, the left-most digit(s) of a reference number identifies the drawing in which the reference number first appears.

### DETAILED DESCRIPTION

A content browser user interface (UI) of a multimedia platform may be configured to display tiles of content that graphically represent particular content items such as, for example and without limitation, movies, television shows, podcasts, videos, livestreams, media channels, applications, etc. Each tile of content can include, for example and without limitation, a thumbnail (e.g., a still image thumbnail, an animated thumbnail such as a graphical image format (GIF) thumbnail, a video or live video thumbnail, etc.), an image preview, a video or live video preview, a livestream view, and/or any other visual rendering or representation of a corresponding content item. Disadvantageously, content browser UIs and/or the tiles of content displayed in a content browser UI typically are not personalized and generally fail to improve (and/or do not assist) the browsing experience of the user. Indeed, the content browser UIs typically provide a monotonous browsing experience for users and fail to improve or increase user engagement with content provided by the content browser UIs. In many cases, the content browser UIs and/or the tiles of content displayed in a content browser UI lack variation and fail to intelligently highlight or emphasize content of interest to the user, which further reduces user engagement.

For example, a content browser UI can include rows of tiles that graphically represent different content items. Each tile can represent a particular content item, such as a movie, television show, podcast, application, channel, livestream, etc. The rows can be used to organize and/or arrange tiles (and associated content items) into groups, categories, collections, clusters, arrangements, etc. To illustrate, each row of tiles can represent a group, category, cluster, collection, and/or arrangement of content items (e.g., a genre, a type of content, a content class or collection, a cluster of content items, a grouping of content items based on one or more attributes and/or commonalities, a content category, etc.). However, each tile in a row or in each row may have the same size, aspect ratio, pattern, and/or other attributes, which makes the scrolling/browsing experience monotonous for the user, fails to highlight certain content for the user, lacks personalization, and may even reduce user engagement with the content and/or the associated platform. The lack of personalization/customization, variety/diversity, adaptation, etc., in the tile, row, and/or configuration of the content browser UI can be increasingly problematic as the number of rows and/or tiles presented in the content browser UI increase, the density of content or corresponding tiles in each group of tiles (e.g., rows) increases, the size of the content browser UI and/or a display of a device presenting the content browser UI decreases, and/or the number of rows and/or tiles that the user scrolls/browses through increases in order to find a content item of interest (particularly in cases where the user scrolls/browses through many rows of tiles such as a threshold amount of rows of tiles).

Moreover, the lack of personalization/customization, variety/diversity, adaptation, etc., in the tile, row, and/or configuration of the content browser UI can increase the likelihood of user abandonment of the content browser UI and thus reduce the user engagement with the content browser UI (and/or content thereof). For example, the user may become frustrated and abandon the browsing session (e.g., exit the content browser UI) when the configuration of the tiles, group(s) of tiles, and/or content browser UI results in the user failing to find relevant or desired content within a certain amount of time and/or within a certain number of groups of tiles (e.g., rows).

In some examples, the configuration of the content browser UI may not consider or account for the capabilities of a media device presenting the content browser UI and/or the network bandwidth of the media device. As a result, the performance of the media device when presenting or loading the content browser UI (and/or specific tiles and/or rows of tiles) may be degraded and/or may negatively impact the experience of the user when engaging with the content browser UI. For example, a media device with less bandwidth and/or a media device that is connected to a network with less than a threshold amount of available bandwidth (and/or more than a threshold amount of network congestion) may take longer to load larger tiles (e.g., tiles having a size above a threshold) and/or groups of larger tiles compared to a media device that has more bandwidth and/or a media device that is connected to a network that has more available bandwidth (and/or less network congestion).

Provided herein are system, apparatus, device, method and/or computer program product embodiments, and/or combinations and/or sub-combinations thereof, for generating customized/personalized content browser UIs and browsing experiences. In some examples, the system, apparatus, device, method and/or computer program product embodiments (and/or combinations and/or sub-combinations thereof) provided herein can generate personalized and/or customized content browser UIs (and/or content thereof such as tiles of content, etc.) that users can use to browse and access content items available through the content browser UIs. In some examples, the system, apparatus, device, method and/or computer program product embodiments (and/or combinations and/or sub-combinations thereof), may intelligently highlight/emphasize content of interest to a user in a content browser UI. That way the provided content browser UI may assist the user in browsing and/or identifying content of interest via the content browser UI, make the content browser UI more user friendly, emphasize content estimated to have a higher likelihood of interest to the user, de-emphasize content estimated to have a lower likelihood of interest to the user, increase user retention/engagement, and/or otherwise improve the user's browsing experience by drawing the attention of the user to certain content (and/or away from certain content) and/or certain variations in the tiles and/or the UI configuration. Additionally, the system, apparatus, device, method and/or computer program product embodiments (and/or combinations and/or sub-combinations thereof), may increase the configuration variety/diversity of the content browser UI. That way the provided content browser UI may avoid or reduce the monotony of the browsing experience otherwise encountered by users with other content browser UIs, intelligently improve the content browsing experience of the user, is user friendly, increase the number of engagements and/or the duration of the engagements between the user and the content browser UI (e.g., browse content and/or play a content item for longer than a predetermined time threshold, increase the content/browsing sessions and session durations, etc.). Additionally, the system, apparatus, device, method and/or computer program product embodiments (and/or combinations and/or sub-combinations thereof) provided herein may, account for device and/or network attributes when providing a content browser UI to a device in order to increase the performance of the content browser UI at the device.

In some cases, to address the foregoing problems, the disclosed technology can determine and/or generate a template for a content browser UI (e.g., a UI template) and one or more templates for one or more groups of tiles (e.g., group templates) presented at the content browser UI. In some examples, a UI template can refer to a template that defines aspects of a content browser UI as a whole or a layout of the content browser UI. In some examples, a UI template can define a structure or layout of the content browser UI, a number of groups (e.g., rows, columns, clouds, inline frames, containers, carousels, grids, geometric shapes, etc.), types of groups and/or group categories to depict via the groups of tiles, a number of tiles to include in each of the number of groups of tiles, an ordering of the groups, a positioning of the groups on the content browser UI, a positioning and/or order of content associated with advertisements. In some instances, the group type/category may be associated with a genre (e.g., action and adventure, anime, children/family, classics, comedies, documentaries, dramas, horror, music, musical, romantic, science fiction, fantasy, sports, thrillers, television (TV) Shows), a media application or platform, and/or a media type (e.g., movie, television show, podcast, music, and livestream or live). In other instances, layouts that may be defined by the UI template include, but are not limited to, a row layout (e.g., row of tiles), a column layout (e.g., a column of tiles), a cluster layout (e.g., a cluster of tiles) and a frame or inline frame of tiles.

In other examples, group template can define aspects of a group of tiles (e.g., row of tiles, a column of tiles, a cluster of tiles, a frame or inline frame of tiles, a category of tiles, an arrangement of tiles, a set or subset of tiles, a collection of tiles, etc.) representing content provided through the content browser UI. In some instances, a group template can define display attributes for each tile of one or more group of tiles and/or the display attributes of the groups of tiles. Examples of the display attributes for the tiles includes, the size(s) of tiles, an aspect ratio(s) of the tiles, a height and/or width of the tiles, a rendering of the tiles in the group of tiles, a representation attribute(s) of the tiles (e.g., a color, a texture, a video and/or video preview, an animation and/or animation preview, a type of tile, a tile pattern, a tile font, a tile orientation, a number of tiles in a group, a sound or interactive sound associated with the tiles, a tile configuration, a tile arrangement, and/or any other a visual attribute). Additionally, examples of display attributes for the groups of tiles includes a size (e.g., height, length, and/or width) of a grouping area of the groups of tiles, and/or a group rendering characteristic (e.g., group depicted as an album, group depicted as a grid, group depicted as a row and/or column, group depicted as a carousel, group depicted as a geometric shape, and a group depicted as a list menu), and a positioning of each of the groups of tiles. In other instances, the group template may define a subgrouping of tiles in a group of tiles (e.g., by genre, type of content, content statistics, user preferences, user interactions, a group attribute, a category of content, content features, group content metadata, a type of content activity and/or interaction, group content ratings or rankings, group content source, group content characteristics, group content timestamps, group content events, group content context signals, group content user engagement data, etc.).

In some examples, the UI template and the group template(s) (e.g., the templates for the groups of tiles) can be determined and/or generated by an artificial intelligence (AI) or machine learning (ML) algorithm(s), such as a multi-armed bandit model (e.g., an upper confidence bound (UCB) model), a transformer model, a convolutional neural network (CNN) model, explore-exploit model, generative neural network and diffusion model and/or any other model. As described herein, the UI template and/or the group template(s) can provide the variety or diversity of the content browser UI, such as variations (e.g., personalization/customization, diversity, modifications/adaptations, etc.) in the configuration of the content browser UI, the grouping of content (e.g., tiles) in the content browser UI, and content (e.g., tiles) presented in the content browser UI, and intelligently highlight or emphasize content of interest to a user of the content browser UI. In some instances, the one or more AI/ML models/algorithms may determine and/or generate templates that are specific or personalized to a user, such as specific to a user's preferences, patterns, context, device, statistics, tendencies, interests, etc.

In some examples, the UI template and/or the group template(s) (e.g., the templates for the groups of tiles) may be based on interactions between the user and the content browser UI (and/or content thereof), user engagement data describing or measuring a user engagement with the content browser UI (and/or content thereof), context information (e.g., location information, time of day information, dates, activity associated with a user interaction with a content browser UI (e.g., activity before, during, and/or after the user interaction), demographics data, user age data, user language data, etc.), user preferences data, user statistics, content metrics from the user or a group of users that includes the user, data describing and/or measuring user interests in different content, content session statistics, affinity signals/scores (e.g., user media platform/channel/application affinity signals (e.g., user preferences for certain channels or media streaming services), user genre affinity signals, user application affinity signals (e.g., user preferences for certain applications), user content affinity signals (e.g., user preferences for certain types of content, certain content sources, etc.), data describing or measuring user behavioral patterns, device information (e.g., type of user device, device resolution, device bandwidth, network bandwidth, device screen size, device performance data, device memory statistics, device storage information, device profile, etc.).

In some instances, the data about user interactions and/or user engagements may include group interactions and/or group engagements. In some cases, the group interactions and/or engagements may characterize one or more interactions between the user (or a group of users that includes the user) and one or more groups of tiles presented on the content browser UI or available for presentation on the content browser UI. In other cases, the user or group interactions and/or engagements may include page interactions and/or engagements. In such cases, the page interactions and/or engagements may characterize one or more interactions between the user (and/or a group of users that includes the user) and a page presented by the content browser UI (e.g., interactions with tiles that cause corresponding content items to be played).

In other examples, the UI template and/or the group templates (e.g., the templates for the groups of tiles) can be based on the device capabilities of the media device used by the user (or to be used by the user) to access the content browser UI and/or characteristics of the network (e.g., available network bandwidth, network congestion, wireless network or wired network, throttled network or unlimited network, network connectivity or connectivity strength, cellular network or local area network, network latency, quality of service (QOS), etc.). For example, if the media device or network has a bandwidth below a threshold and/or the media device has less than a threshold amount of resources (e.g., memory, processing resources, etc.), the templates can be adapted to define tiles that use less network and/or device resources, such as tiles that are smaller in size, etc. In such approaches, the performance of the media device may be optimized or improved when presenting or loading the content browser UI by taking into account device and/or network characteristics (e.g., make loading times as short as possible given the device capabilities and/or the available network bandwidth). For example, a model may select templates that specify tiles for the content browser UI that are smaller in size or of a lower pixel quality (e.g., have less pixels) for a media device with a smaller screen and/or a media device that is connected to a network with less available bandwidth. This can reduce the loading times when presenting or loading such tiles at the media device. In another example, the model may select templates that specify tiles for the content browser UI that are larger in size or of a higher pixel quality (e.g., have more pixels) for a media device with a larger screen and/or a media device that is connected to a network with more available bandwidth. In such example, such media devices may present larger and/or higher pixel quality tiles without unnecessarily or excessively increasing a latency in the UI loading times.

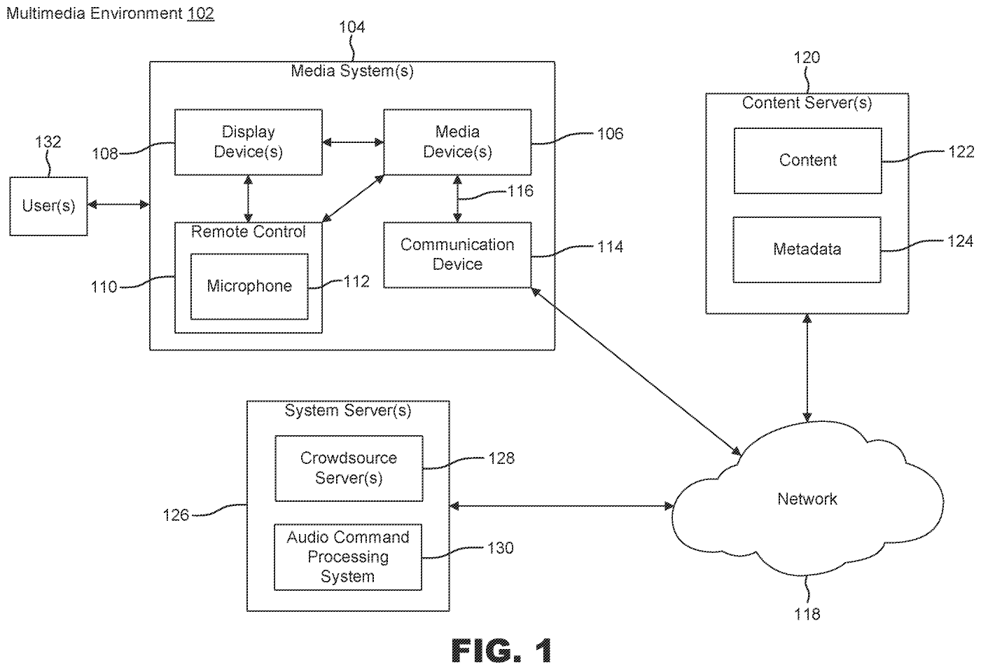

Various embodiments and aspects of this disclosure may be implemented using and/or may be part of a multimedia environment 102 shown in FIG. 1. It is noted, however, that multimedia environment 102 is provided for illustrative purposes and is not limiting. Examples and embodiments of this disclosure may be implemented using, and/or may be part of, environments different from and/or in addition to the multimedia environment 102, as will be appreciated by persons skilled in the relevant art(s) based on the teachings contained herein. An example of the multimedia environment 102 shall now be described.

### Multimedia Environment

FIG. 1 illustrates a block diagram of a multimedia environment 102, according to some examples of the present disclosure. In a non-limiting example, multimedia environment 102 may be directed to streaming media. However, this disclosure is applicable to any type of media (instead of or in addition to streaming media), as well as any mechanism, means, protocol, method and/or process for distributing media.

The multimedia environment 102 may include one or more media systems 104. A media system 104 could represent a family room, a kitchen, a backyard, a home theater, a school classroom, a library, a car, a boat, a bus, a plane, a movie theater, a stadium, an auditorium, a park, a bar, a restaurant, or any other location or space where it is desired to receive and play streaming content. User(s) 132 may operate with the media system 104 to select and consume content.

Each media system 104 may include one or more media devices 106 each coupled to one or more display devices 108. It is noted that terms such as “coupled,” “connected to,” “attached,” “linked,” “combined” and similar terms may refer to physical, electrical, magnetic, logical, etc., connections, unless otherwise specified herein.

Media device 106 may be a streaming media device, DVD or BLU-RAY device, audio/video playback device, cable box, and/or digital video recording device, to name just a few examples. Display device 108 may be a monitor, television (TV), computer, smart phone, tablet, wearable (such as a watch or glasses), appliance, internet of things (IoT) device, and/or projector, to name just a few examples. In some examples, media device 106 can be a part of, integrated with, operatively coupled to, and/or connected to its respective display device 108.

Each media device 106 may be configured to communicate with network 118 via a communication device 114. The communication device 114 may include, for example, a cable modem or satellite TV transceiver. The media device 106 may communicate with the communication device 114 over a link 116, wherein the link 116 may include wireless (such as WiFi) and/or wired connections.

In various examples, the network 118 can include, without limitation, wired and/or wireless intranet, extranet, Internet, cellular, Bluetooth, infrared, and/or any other short range, long range, local, regional, global communications mechanism, means, approach, protocol and/or network, as well as any combination(s) thereof.

Media system 104 may include a remote control 110. The remote control 110 can be any component, part, apparatus and/or method for controlling the media device 106 and/or display device 108, such as a remote control, a tablet, laptop computer, smartphone, wearable, on-screen controls, integrated control buttons, audio controls, or any combination thereof, to name just a few examples. In some examples, the remote control 110 wirelessly communicates with the media device 106 and/or display device 108 using cellular, Bluetooth, infrared, etc., or any combination thereof. The remote control 110 may include a microphone 112, which is further described below.

The multimedia environment 102 may include a plurality of content servers 120 (also called content providers, channels or sources 120). Although only one content server 120 is shown in FIG. 1, in practice the multimedia environment 102 may include any number of content servers 120. Each content server 120 may be configured to communicate with network 118.

Each content server 120 may store content 122 and metadata 124. Content 122 may include any combination of music, videos, movies, TV programs, multimedia, images, still pictures, text, graphics, gaming applications, advertisements, programming content, public service content, government content, local community content, software, and/or any other content or data objects in electronic form.

In some examples, metadata 124 comprises data about content 122. For example, metadata 124 may include associated or ancillary information indicating or related to writer, director, producer, composer, artist, actor, summary, chapters, production, history, year, trailers, alternate versions, related content, applications, and/or any other information pertaining or relating to the content 122. Metadata 124 may also or alternatively include links to any such information pertaining to or relating to the content 122. Metadata 124 may also or alternatively include one or more indexes of content 122, such as but not limited to a trick mode index.

The multimedia environment 102 may include one or more system servers 126. The system servers 126 may operate to support the media devices 106 from the cloud. It is noted that the structural and functional aspects of the system servers 126 may wholly or partially exist in the same or different ones of the system servers 126.

The media devices 106 may exist in thousands or millions of media systems 104. Accordingly, the media devices 106 may lend themselves to crowdsourcing embodiments and, thus, the system servers 126 may include one or more crowdsource servers 128.

For example, using information received from the media devices 106 in the thousands and millions of media systems 104, the crowdsource server(s) 128 may identify similarities and overlaps between closed captioning requests issued by different users 132 watching a particular movie. Based on such information, the crowdsource server(s) 128 may determine that turning closed captioning on may enhance users' viewing experience at particular portions of the movie (for example, when the soundtrack of the movie is difficult to hear), and turning closed captioning off may enhance users' viewing experience at other portions of the movie (for example, when displaying closed captioning obstructs critical visual aspects of the movie). Accordingly, the crowdsource server(s) 128 may operate to cause closed captioning to be automatically turned on and/or off during future streamings of the movie.

The system servers 126 may also include an audio command processing system 130. As noted above, the remote control 110 may include a microphone 112. The microphone 112 may receive audio data from users 132 (as well as other sources, such as the display device 108). In some examples, the media device 106 may be audio responsive, and the audio data may represent verbal commands from the user 132 to control the media device 106 as well as other components in the media system 104, such as the display device 108.

In some examples, the audio data received by the microphone 112 in the remote control 110 is transferred to the media device 106, which is then forwarded to the audio command processing system 130 in the system servers 126. The audio command processing system 130 may operate to process and analyze the received audio data to recognize the user 132's verbal command. The audio command processing system 130 may then forward the verbal command back to the media device 106 for processing.

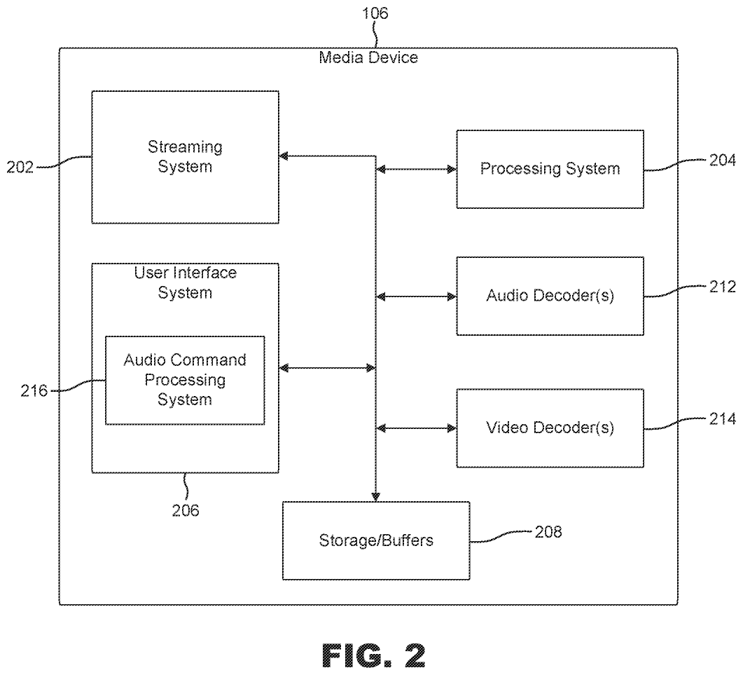

In some examples, the audio data may be alternatively or additionally processed and analyzed by an audio command processing system 216 in the media device 106 (see FIG. 2). The media device 106 and the system servers 126 may then cooperate to pick one of the verbal commands to process (either the verbal command recognized by the audio command processing system 130 in the system servers 126, or the verbal command recognized by the audio command processing system 216 in the media device 106).

FIG. 2 illustrates a block diagram of an example media device 106, according to some embodiments. Media device 106 may include a streaming system 202, processing system 204, storage/buffers 208, and user interface module 206. As described above, the user interface module 206 may include the audio command processing system 216.

The media device 106 may also include one or more audio decoders 212 and one or more video decoders 214. Each audio decoder 212 may be configured to decode audio of one or more audio formats, such as but not limited to AAC, HE-AAC, AC3 (Dolby Digital), EAC3 (Dolby Digital Plus), WMA, WAV, PCM, MP3, OGG GSM, VVC, FLAC, AU, AIFF, and/or VOX, to name just some examples.

Similarly, each video decoder 214 may be configured to decode video of one or more video formats, such as but not limited to MP4 (mp4, m4a, m4v, f4v, f4a, m4b, m4r, f4b, mov), 3GP (3gp, 3gp2, 3g2, 3gpp, 3gpp2), OGG (ogg, oga, ogv, ogx), WMV (wmv, wma, asf), WEBM, FLV, AVI, QuickTime, HDV, MXF (OP1a, OP-Atom), MPEG-TS, MPEG-2 PS, MPEG-2 TS, WAV, Broadcast WAV, LXF, GXF, and/or VOB, to name just some examples. Each video decoder 214 may include one or more video codecs, such as but not limited to H.263, H.264, H.265, VVC, AVI, HEV, MPEG1, MPEG2, MPEG-TS, MPEG-4, Theora, 3GP, DV, DVCPRO, DVCPRO, DVCProHD, IMX, XDCAM HD, XDCAM HD422, and/or XDCAM EX, to name just some examples.

Now referring to both FIGS. 1 and 2, in some examples, the user 132 may interact with the media device 106 via, for example, the remote control 110. For example, the user 132 may use the remote control 110 to interact with the user interface module 206 of the media device 106 to select content, such as a movie, TV show, music, book, application, game, etc. The streaming system 202 of the media device 106 may request the selected content from the content server(s) 120 over the network 118. The content server(s) 120 may transmit the requested content to the streaming system 202. The media device 106 may transmit the received content to the display device 108 for playback to the user 132.

In streaming examples, the streaming system 202 may transmit the content to the display device 108 in real time or near real time as it receives such content from the content server(s) 120. In non-streaming examples, the media device 106 may store the content received from content server(s) 120 in storage/buffers 208 for later playback on display device 108.

### Example Processes for Generating Customized/Personalized Content Browser UIs and Browsing Experiences

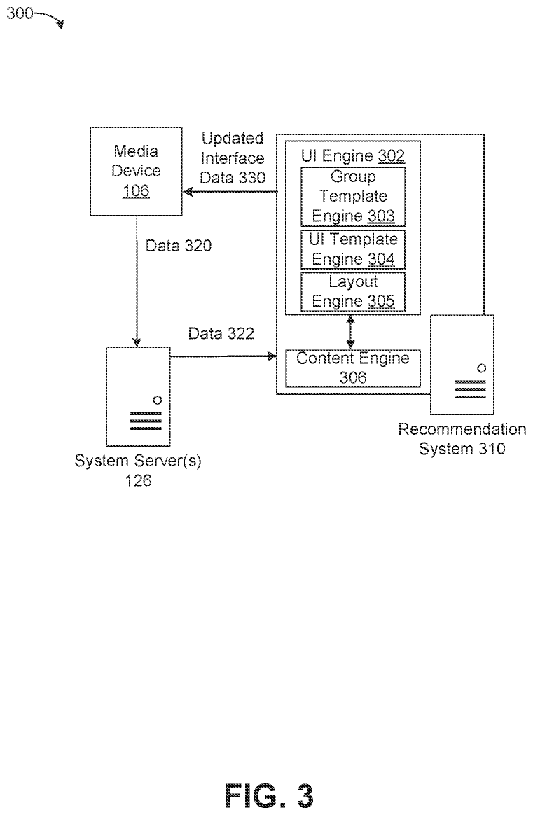

Referring to FIG. 3, multimedia environment 102 may include one or more additional computing systems, such as recommendation system 310. The one or more additional computing systems may implement operations to perform the example processes described herein. For example, and without limitation, in some cases, recommendation system 310 may determine, select, and/or generate customized/personalized content browser user interfaces (UIs) and browsing experiences as described herein. A content browser UI may be configured to display tiles of content (and/or any other form, type, and/or configuration of content in addition to or instead of tiles including any form of textual content, visual content, and/or audio content) that graphically represent content items (e.g., movies, television shows, podcasts, videos, livestreams, media channels, applications, etc.) that a user(s) can access via the content browser UI (e.g., via the displayed tiles).

For example, a displayed content browser UI may include groups of content items, such as a first group of content items associated with romantic comedy movies and a second group of content items associated with documentaries. In some instances, for each of the groups of content items displayed on the content browser UI, the displayed content browser UI may include tiles of content where each tile represents a content item associated with the corresponding group of content items. In some aspects, the tiles displayed on the content browser UI corresponding to the first group of content items may be displayed in a manner that visually depicts such tiles (and associated content items) as corresponding to the first group. Similarly, the tiles displayed on the content browser UI corresponding to the second group of content items may be displayed in a manner that visually depicts such tiles (and associated content items) as corresponding to the second group. As described herein, the user can access the content browser UI from media device 106 and can browse the groups of content items based on the group of tiles associated with the first group and the group of tiles associated with the second group. The arrangement of the groups of tiles can indicate to the user which tiles (and associated content) correspond to the first group and, which tiles (and associated content) correspond to the second group. The arrangement may facilitate the user's browsing experience. In some instance, the user can interact (e.g., via inputs from media device 106) with any tile (and associated content item) displayed on the content browser UI to access information associated with the tile (and/or associated content item), view content associated with the tile, execute (e.g., play, resume, stop, pause, like/dislike, etc.) a content item associated with the tile, modify (e.g., remove/delete, add, edit, label, tag, comment, etc.) the tile and/or content associated with the tile, and/or otherwise interact with the tile (e.g., save, subscribe, rank, move, activate, etc.) and/or the content item associated with the tile.

As further described herein, recommendation system 310 can generate customized/personalized content browser UIs, including customized/personalized groupings of content representations (e.g., tiles), customized/personalized configurations of the content representations, etc. In some examples, recommendation system 310 may intelligently highlight/emphasize content of interest to a user in a content browser UI, such as tiles (and/or associated content items) corresponding to content items of interest to the user. The customized/personalized content browser UI may assist the user in browsing and/or identifying content items of interest via the content browser UI, provide a more user-friendly interface for the user, emphasize or highlight content items (and/or associated content representations such as tiles) estimated to have a higher likelihood of interest to the user, de-emphasize content items (and/or associated content representations) estimated to have a lower likelihood of interest to the user, increase user retention/engagement, and/or otherwise improve the user's browsing experience by drawing the attention of the user to certain content items (and/or away from certain content items) and/or certain variations in the tiles and/or the UI configuration. The customized/personalized content browser UI may increase the configuration variety/diversity of the content browser UI in order to avoid or reduce the monotony of the browsing experience otherwise encountered by users with other content browser UIs, intelligently improve the content browsing experience of the user, increase the number of interactions and/or the duration of the interactions between the user and the content browser UI (e.g., browse content and/or play a content item for longer than a predetermined time threshold, increase the content/browsing sessions and session durations, etc.), increase user engagement with content and/or the content browser UI, etc.

FIG. 3 is a diagram illustrating an example system 300 for determining, selecting, and/or generating customized/personalized content browser UIs and browsing experiences, according to some examples of the present disclosure. In some examples, recommendation system 310 may generate the customized/personalized content browser UIs by determining, selecting, and/or generating a UI template used to define aspects of the content browser UI and one or more group templates used to define aspects of groups of content displayed in the content browser UI, such as groups of displayed tiles corresponding to respective content items. In some aspects, the UI template and/or the one or more group templates can be generated based on data identifying and/or characterizing interactions between the users and the content browser UIs. Moreover, the UI template may define aspects of a content browser UI as a whole, and the one or more group templates may define aspects of one or more groups of tiles (or any other visual content representations) included (e.g., displayed) in the content browser UI. In such examples, each tile from the groups of tiles may represent a content item provided through the content browser UI, such as a movie, television show, podcast, video, livestream, media channel, application, etc. As described herein, the UI template and/or group templates may be used to customize a content browser UI in a way that highlights or emphasizes content of interest to a user of the content browser UI, draw the user's attention to certain tiles or groups of tiles, assist users in browsing and selecting content via the content browser UI, and/or vary how content is rendered/presented in the content browser UI (e.g., to improve the user's browsing experience and avoid or reduce browsing monotony).

In some examples, recommendation system 310 can include, be a part of, and/or be implemented by one or more hardware and/or virtual systems such as, for example and without limitation, one or more server computers, datacenters and/or datacenter devices, cloud computing infrastructure devices/components, software containers, virtual machines, computer devices, cloud application services, and/or any other computing systems. As illustrated in FIG. 3, recommendation system 310 may include UI engine 302 and content engine 306. UI engine 302 can include group template engine 303, UI template engine 304, and layout engine 305. In some examples, UI engine 302, content engine 306, group template engine 303, UI template engine 304, and/or layout engine 305 can each include or represent one or more software models and/or algorithms. For example, UI engine 302, content engine 306, group template engine 303, UI template engine 304, and/or layout engine 305 can each include or represent one or more artificial intelligence (AI) or machine learning (ML) models such as, for example and without limitation, a multi-armed bandit model (e.g., an upper confidence bound (UCB) model), a convolutional neural network (CNN) model, a transformer model, a generative adversarial network (GAN) model, a large language model (LLM), explore-exploit model, generative neural network and diffusion model, and/or any other AI/ML model. In some cases, UI engine 302, content engine 306, group template engine 303, UI template engine 304, and/or layout engine 305 can each additionally or alternatively include or represent one or more other types of models/algorithms such as, for example, one or more heuristic algorithms.

As described herein, UI engine 302 of recommendation system 310 may perform any of the example processes described herein to determine, select, and/or generate the customized/personalized content browser UIs. In some examples, UI engine 302 may implement group template engine 303, UI template engine 304, and layout engine 305 to perform any of the example processes described herein to determine, select, and/or generate the customized/personalized content browser UIs. Group template engine 303 can be configured to determine, select, and/or generate group templates (e.g., templates for groups of content representations displayed in content browser UIs, such as tiles) and UI template engine 304 can be configured to determine, select, and/or generate one or more UI templates (e.g., templates for a content browser UI as a whole). As described herein, the UI template and/or the group templates may be used to configure (e.g., customize) a content browser UI.

In some examples, media device 106 can display a content browser UI and collect, track, and/or generate data 320 associated with user inputs/interactions, device events and/or interactions, session information, context information, user information, device information, UI information, network information, timestamps, and/or other information relating to the user, device, context, session, and/or content browser UI. For example, a user operating media device 106 may use media device 106 to interact with a content browser UI (and/or associated content). Such interactions can be used to generate data identifying and/or characterizing interactions between the user and the content browser UI (and/or content thereof). The data identifying and/or characterizing interactions between the user and the content browser UI (and/or content thereof) may be included in data 320.

In some aspects, the data 320 can include information about any user interactions with the content browser UI (and/or associated content), such as user inputs, content selections, user navigation actions, user feedback, user replies to prompts and/or events, etc. In some cases, data 320 can additionally or alternatively include context information (e.g., location of media device 106, date and/or time information, environment information such as type of environment (e.g., mobile environment, business environment, home environment, public environment, etc.) and/or environment attributes (e.g., weather, ambient light levels, etc.), device information (e.g., type of device, device capabilities, device events, device profile, device preferences, device metrics and/or statistics, etc.), user information (e.g., demographics, user preferences, historical user information, user profile, etc.), network information (e.g., bandwidth, network latency, type of network such as wireless/wired network or public/private network, network congestion, quality-of-service, etc.), and/or any other information.

In some instances, the data about the interactions between the user and the content browser UI may include timestamps or data indicating a time and/or date of each identified and characterized interaction. Moreover, data 320 may additionally or alternatively include other information about interactions between the user and the content browser UI, such as information about an absence of certain interactions or types of interactions and/or information about a level of engagement of the user with the content browser UI and/or an associated content item (and/or one or more portions thereof). For instance, data 320 may include information indicating that playback of a content item associated with a tile in the content browser UI continued without interruption for a certain period of time (e.g., that the user did not pause, stop, or otherwise interacted with a playback of the content item) and/or until a certain point (e.g., until the end of the content item or a segment of the content item, until a break in the content item, until an event associated with the content item, etc.), information indicating that the user did not (or did) respond to a prompt displayed in association with a content item, information indicating the user kept scrolling without interacting with content in the content browser UI, etc. As such, the information about user interactions and/or lack of user interactions may be used to determine a user engagement level with the content browser UI and/or the associated content item (and/or portions thereof). The determined user engagement level may be included in data 320 described below. To illustrate, information indicating that playback of a content item associated with a tile continued without interruption until the end can indicate that the user was engaged with the content item throughout playback of the content item, while information indicating that a user did not respond to a prompt displayed in association with a content item can indicate that the user was distracted or otherwise disengaged (or less engaged) with the content item. Thus, such information about user interactions and/or lack thereof can be used to generate information about the user engagement level between the user and the content browser UI and/or particular content. The generated or determined information about the user engagement level between the user and the content browser UI and/or the particular content may be included in data 320.

In some examples, media device 106 may provide data 320 (and/or portions of data 320 and/or any other associated data) to recommendation system 310. In other examples, a backend system (e.g., system server(s) 126, recommendation system 310, etc.) may collect data generated from and/or based on interactions between media device 106 (e.g., and thus the user associated with media device 106) and the content browser UI, which can be included in data 320 and/or used to generate data included in data 320. For example, in some instances, media device 106 may interact with a content browser UI and system server(s) 126 monitor such interaction(s) and generate or collect data about such interaction(s). System server(s) 126 may include such data about the interaction(s) in data 320 and/or generate data 320 based on such data bout the interaction(s). System server(s) 126 may then provide data 320 to recommendation system 310 for use as described herein.

In some instances, and as illustrated in FIG. 3, media device 106 may provide data 320 to system server(s) 126, and system servers 126 may generate data 322 based on data 320 and provide data 322 to recommendation system 310. In some cases, data 322 can include or be the same as data 320. In some aspects, data 322 can include data 320 and/or data generated based on data 320. For example, in some examples, data 322 can include data about interactions between the user and the content browser UI, which can be obtained and/or generated from data 320. To illustrate, data 322 can include information about navigation inputs (e.g., scrolling, searching, playing/stopping/pausing/forwarding/rewinding content, selecting content, requesting content, dismissing content, activating content, subscribing to content or unsubscribing from content, organizing content, adding or removing content, editing content, etc.) provided by the user at media device 106, user feedback provided by the user (e.g., likes/dislikes, ratings/rankings, user comments, etc.), responses to prompts or events provided by the user, and/or other user activity (e.g., other user inputs). In some cases, data 322 can include data about user interactions at media device 106 as well as any other information from data 320 such as, for example, device data, network data, context data, user data, etc.

In some aspects, data 322 may include data that measures, tracks, includes, and/or describes/characterizes a browsing behavior of the user, such as whether the user has scrolled certain content, whether the user has interacted with certain content or groups of content, etc. In some cases, data 322 may include data that predicts or estimates user behavior such as whether the user is more likely to scroll horizontally or vertically, whether the user has a certain likelihood of scrolling or accessing certain content within a content browser UI, whether the user has a certain likelihood of having interest in a particular group of content, whether the user is more likely to be interested in certain type(s) of content than other type(s) of content, whether the user's interest and/or attention is more likely to be drawn to certain types and/or configuration of content, etc.

Recommendation system 310 can use data 322 to determine, select, and/or generate updated interface data 330, as further described below. In some examples, group template engine 303 and UI template engine 304 can use data 322 to determine, select, and/or generate templates used to determine, select, and/or generate updated interface data 330, such as UI templates and group templates. For example, group template engine 303 and UI template engine 304 may use data about interactions between the user and the content browser UI (e.g., data 322), to determine, select, and/or generate the one or more group templates and the UI template, respectively. Examples of data about interactions that can be included in data 322 may include, but are not limited to, selecting a tile (and/or associated content) displayed on the content browser UI, playing a content item corresponding to the tile (e.g., by interacting with the tile and/or one or more associated interface elements), modifying (e.g., pausing, rewinding, forwarding, adjusting a playback speed, maximizing, minimizing, ending, etc.) playback of the content item corresponding to the tile, stopping playback of the content item corresponding to the tile, providing feedback (e.g., liking, disliking, rating/ranking, commenting, blocking, etc.) about a content item associated with the tile, removing or closing out the content item (and/or an associated interface element, such as a media player, an interface window, etc.), subscribing to the content item (and/or an associated channel, application, content provider, etc.), adding the content item to a user favorites category (e.g., designing the content item as a favorite), input provided in response to a prompt associated with the content item, interactions related to searching for a content item, and interactions related to navigating the content browser UI (e.g., scrolling vertically, scrolling horizontally, etc.).

In some examples, UI template engine 304 may determine, select, and/or generate a UI template for customizing the content browser UI, based on one or more portions of data 322. For example, UI template engine 304 may use information included in data 322 that measures, describes, and/or otherwise relates to one or more user interactions with the content browser UI, to generate a UI template used to customize the content browser UI for the user (e.g., dynamically customize the content browser UI while media device 106 displays/renders the content browser UI or customize subsequent presentations/renderings of the content browser UI by media device 106). In some instances, the UI template may define aspects of a content browser UI as a whole, such as a layout or structure of the content browser UI. For instance, the UI template may define the number of groups of content or content items (e.g., tiles or other content representations) to include in the content browser UI or, for instances where the content browser UI includes multiple interfaces (e.g., pages), a number of groups of tiles for each of the multiple pages, categories or group type (e.g., genre, media application/platform, and/or media type) associated with each of the number of groups of content, a number of content items or content (e.g., tiles or other content representations) for each of the number of groups of content, a layout of each of the number of groups of tiles, an overall layout of the content browser UI (e.g., an ordering and position of each of the groups of tiles), a display arrangement for the groups of tiles (e.g., display groups in rows, display groups in columns, display groups as a grid, display groups as a carousel, etc.), an order for displaying groups of tiles and/or tiles in groups of tiles, a group type or category for each group of tiles, and/or any other UI configuration information.

In some examples, group template engine 303 may generate one or more group templates for customizing one or more groups of content (e.g., tiles or other content representations, etc.) in the content browser UI, based on one or more portions of data 322. For example, group template engine 303 may use information included in data 322 that measures, describes, and/or otherwise relates to one or more user interactions with a content browser UI, to generate one or more group templates used to customize one or more groups of content (e.g., one or more groups of tiles or other content representations, etc.) displayed in (and/or to be displayed in) a customized content browser UI. In some instances, the one or more group templates may define aspects of one or more groups of tiles of content that may be presented by the content browser UI. For instance, the group templates may define display attributes for each tile (or other content representations) included in each of the groups of contents and/or the display attributes of each of the groups of contents. In some aspects, examples of the display attributes for the tiles includes, the size(s) of tiles, an aspect ratio(s) of the tiles, a height and/or width of the tiles, a rendering of the tiles in the group of tiles, an representation attribute(s) of the tiles (e.g., a color, a texture, an animation, a type of tile, a tile pattern, a tile font, a tile orientation, a number of tiles in a group, a sound or interactive sound associated with the tiles, a tile configuration, a tile arrangement, and/or any other a visual attribute). In some cases, examples of display attributes for the groups of tiles includes a size (e.g., height, length, and/or width) of a grouping area of the groups of tiles, and/or a group rendering characteristic (e.g., group depicted as an album, group depicted as a grid, group depicted as a row and/or column, group depicted as a carousel, group depicted as a geometric shape), and a positioning of each of the groups of tiles.

In some examples, the portions of data 322 used by UI template engine 304 to generate a UI template may describe, represent, measure, and/or correspond to interactions between a user, such as user 132, and the content browser UI as a whole and/or interactions between the user and one or more portions of the content browser UI. In some instances, UI template engine 304 may use portions of data 322, such as portions of data 322 that measure, track, include, and/or describe/characterize the browsing behavior of the user, user engagement information in data 322, device information in data 322, network information in data 322, user information in data 322, context information in data 322, content-related information in data 322, user activity information in data 322, etc., to determine, select and/or generate a UI template for customizing the content browser UI for the user. As described herein, the UI template. To illustrate, UI template engine 304 can use data 322 to determine, select, and/or generate a UI template that specifies the number of groups of tiles to include in the content browser UI (or for instances where the content browser UI includes multiple interfaces (e.g., pages), the number of groups of tiles for each of the multiple pages), the number of tiles to include in each of the number of groups of tiles, the layout of each of the number of groups of tiles, the overall layout of the content browser UI (e.g., an ordering and position of each of the groups of tiles), the display arrangement for the groups of tiles, the order for displaying groups of tiles and/or tiles in groups of tiles, the group type or category of each group of tiles, and/or any other UI configuration information.

In some cases, UI template engine 304 may use engagement information in data 322 to determine, select and/or generate the UI template. In some instances, the engagement information may be part of or included in data 322. As described herein, the engagement information may describe or measure a level, quality, and/or type of engagement of the user (e.g., user interest in, user attention in) with the content browser UI (and/or content thereof), such as a level, quality, and/or type of user interest, user attention, and/or user focus in the content browser UI (and/or content thereof). For example, the engagement data may indicate how engaged (e.g., how interested) the user is with the content browser UI and/or content of the content browser UI. UI template engine 304 determine how engaged the user is with the content browser UI and/or content of the content browser UI based on the engagement data. In some cases, UI template engine 304 may determine a category or type of group for one or more of the groups of content identified in the UI template, and/or the ordering and position of each of the groups of tiles (e.g., the top half of the content browser UI may be one group or split into two groups of tiles) based on how engaged the user is with the content browser UI and/or the content of the content browser UI.

For instance, UI template engine 304 may identify a level of engagement of user 132 and one or more genres, media applications/platforms, and/or media types of content or content items (e.g., a value corresponding to the level of engagement), based on the engagement data of user 132. Additionally, UI template engine 304 may determine or identify, for each genre, media application/platform and/or media type, a level of engagement of user 132 that satisfies an engagement criteria, such as level of engagement (e.g., a value corresponding to the level of engagement). Moreover, UI template engine 304 may generate a UI template that the categories or group types as including one or more genres, media applications/platforms, and/or media types with levels of engagement that satisfy the engagement criteria (e.g., a level of engagement that is greater than or equal to a threshold level of engagement).

In some cases, UI template engine 304 may use browsing behavior of the user, such as user 132, to determine, select and/or generate the UI template. For instance, UI template engine 304 may determine user 132 is more likely to scroll horizontally based on user interaction information in data 322. Based on determining the user is more likely to scroll horizontally, UI template engine 304 may determine a number of groups of tiles that would fit a screen of a corresponding display device 108 of media device 106 without user 132 needing to scroll vertically for additional groups of tiles. Additionally, UI template engine 304 may determine the layout for each of the number of groups of content may be a row layout based on determining user 132 is more likely to scroll horizontally. Accordingly, UI template engine 304 may determine, select, and/or generate a UI template specifying a number of groups of tiles to display based on the number of groups of tiles that would fit the screen of the corresponding display device 108 and specifying the row layout for each group of tiles. In some instances, UI template engine 304 may determine the number of tiles to be included in each of the number of groups of tiles associated with a horizontal scrolling behavior may be more than the number of tiles to be included in each of the number of groups of tiles associated with a vertical scrolling behavior. Accordingly, UI template engine 304 may determine, select, and/or generate a UI template that specifies or allows more tiles in each group of tiles than in other cases where the user is more likely to perform vertical scrolling than horizontal scrolling.

In another instance, UI template engine 304 may determine user 132 is more likely to scroll vertically based on data 322 (e.g., based on user interactions information in data 322). Based on determining user 132 is more likely to scroll vertically, UI template engine 304 may determine a number of groups of tiles that would fit a screen of a corresponding display device 108 of media device 106 without user 132 needing to scroll horizontally for additional groups of tiles. Additionally, UI template engine 304 may determine the layout for each of the number of groups of tiles may be a column layout based on determining user 132 is more likely to scroll vertically. Accordingly, UI template engine 304 may determine, select, and/or generate a UI template specifying a number of groups of tiles to display based on the number of groups of tiles that would fit the screen of the corresponding display device 108 and specifying the column layout for each group of tiles. In some instances, UI template engine 304 may determine the number of tiles to be included in each of the number of groups of tiles associated with a vertical scrolling behavior may be more than the number of tiles to be included in each of the number of groups of tiles associated with a horizontal scrolling behavior. Accordingly, UI template engine 304 may determine, select, and/or generate a UI template that specifies or allows more tiles in each group of tiles than in other cases where the user is more likely to perform horizontal scrolling than vertical scrolling.

In another instance, UI template engine 304 may determine user 132 has scrolled past groups of tiles associated with live stream content without interacting with any of the tiles included in the group of tiles associated with live stream content. Based on such a determination, UI template engine 304 may determine, select and/or generate a UI template that indicates groups of tiles associated with live stream content may be deemphasized compared to groups of tiles associated with non-live stream content, such as movies. For instance, the UI template may indicate the group of tiles associated with live stream content may be positioned lower the content browser UI compared to group of tiles associated with non-live stream content.

In some cases, UI template engine 304 may use context information in data 322 to determine, select, and/or generate a UI template. As described herein, the context information in data 322 may include location information associated with the location of the user and/or media device 106 (e.g., a geolocation and/or geocoordinates associated with the user and/or media device 106), time/date information indicating one or more times/dates of one or more user interactions and/or one or more instances the user accessed the content browser UI and/or a current time associated with a user session, duration information indicating a time duration of each time the user accessed the content browser UI (and/or content thereof), activities information identifying and characterizing an activity of the user (e.g., before, during and/or after the user interaction), demographic information associated with the user, language information associated with the user (e.g., a language preference of the user), age information associated with the user, information about a platform used by the user and/or associated with media device 106 (e.g., a mobile platform, a smart television or set-top box, a desktop computer, etc.), and/or any other context information.

For instance, based on activities information associated with user 132, UI template engine 304 may identify each instance user 132 interacts with content items associated documentaries and interactions or activities before, during and/or after each instance. Additionally, UI template engine 403 may determine which of the activities before, during and/or after each instance have a certain sentiment, such as which activities have a positive sentiment (e.g., playing the corresponding documentary content item for more than a predetermined threshold of time, selecting the “like” button, etc.). Moreover, UI template engine 304 may determine whether the number of positive activities is greater than or equal to a corresponding predetermined threshold number of positive activities. Based on determining the number of positive activities is greater than or equal to a corresponding predetermined threshold number of positive activities, UI template engine 304 may determine the user may be interested in content items associated with documentaries. Accordingly, UI template engine 403 may determine at least one of the number of groups of tiles may be associated with the documentary group type. In some instances, and as described herein, UI template engine 304 may, based on activities information associated with user 132, use one or more AI/ML models/algorithms to determine which of the activities before, during and/.or after each instance have a certain sentiment (e.g., a positive activity), and whether the number of instances of a certain sentiment (e.g., a positive activity) is greater than or equal to a corresponding predetermined threshold number of instances of the certain sentiment.

In another instance, based on time/date information, UI template engine 403 may determine a current time associated with a session between user 132 and a content browser UI displayed at media device 106. Additionally, based on the current time and any data indicating genre affinities and/or media platform or application affinities, as described herein, UI template engine 304 may determine any time-sensitive content items that may be of interest to user 132, such as live-stream content items, content items that may be removed from the multimedia environment 102 within a threshold period of time, and/or trending content items. Based on determining user 132 may be interested in time-sensitive content items, UI template engine 304 may determine at least one of the number of groups of tiles is to be associated with the time-sensitive content items. In some instances, UI template engine 403 may generate a UI template that indicates at least one of the number of groups of tiles is to be associated with the time-sensitive content items along with the identified the time-sensitive content items of interest. In some instances, and as described herein, UI template engine 304 may, based on time/date information associated with user 132, use one or more AI/ML models/algorithms to determine the time-sensitive content items that may be of interest to user 132.

In another instance, based on language information associated with user 132, UI template engine 304 may determine user 132 prefers a particular language, such as Mandarin. Additionally, UI template engine 304 may determine at least one of the number of groups of tiles may be associated with the content items that are in the preferred language (either dubbed or originally) and/or have subtitles in that preferred language. In some instances, the language information may be obtained from account data of user 132. In some cases, UI template engine 304 may parse account data of user 132 to obtain the language information.

In another instance, based on location information, UI template engine 304 may determine a location associated with user 132. Additionally, UI template engine 304 may obtain account data of other users associated with a similar location(s). In some instances, the account data of other users may be included in data 322 or UI template engine 304 may obtain the account data of other users from system server(s) 126. Moreover, UI template engine 304 may determine group types or categories that the majority of other users have included in corresponding content browser UIs based on the account data of the other users. Further, UI template engine 304 may include one or more of the group types or categories the majority of other users have included in corresponding content browser UIs in the number of groups of tiles specified in the UI template.

In various cases, UI template engine 304 may use user information in data 322 of a user, such as user 132, to determine, select and/or generate the UI template. In some instances, the user information may include an indication of the age of the user. In such instances, UI template engine 304 may determine, for a UI template, a group type or category for each of the number of groups of tiles based on the indication of the age of the user. By way of example, UI template engine 304 may determine user 132 is 36 years old based on the account data of user 132 included in data 322. Additionally, data 322 may include, or UI template engine 304 may obtain, account data of other users with similar age or within a particular age range. Moreover, UI template engine 304 may determine, based on the account data of the other users, group types or categories that the majority of the other users have included in corresponding content browser UIs. Further, UI template engine 304 may include one or more of the group types or categories the majority of the other users have included in corresponding content browser UIs in the number of groups of tiles of user 132.

In some cases, UI template engine 304 may use content-related information in data 322 to determine, select, and/or generate a UI template. As described herein, the content-related data may identify and/or characterize a genre affinity of content items the user interacted with, predicted affinity of other genres the user may be interested in, and/or media platform/application affinity for the user. UI template engine 304 may determine anything that should be specified by the UI template based on the content-related data. For instance, UI template engine 304 may determine a group type or category for each of the number of groups of tiles specified in the UI template based on the content-related data.

By way of example, UI template engine 304 may determine user 132 may have an affinity for content items associated with anime based on the content-related information in data 322. Additionally, UI template engine 304 may determine whether the affinity for content items associated with anime is greater than or equal to a predetermined affinity threshold value. Based on determining the affinity for content items associated with anime is greater than or equal to a predetermined affinity threshold value, UI template engine 304 may determine at least one of the number of groups of tiles specified in the UI template is to be associated with the anime group type. In some instances, and as described herein, UI template engine 304 may, based on content-related information associated with user 132, use one or more AI/ML models/algorithms to determine whether the affinity for content items associated with anime is greater than or equal to a predetermined affinity threshold value.

In another example, UI template engine 304 may determine a predicted affinity for content items associated with musicals that user 132 may be interested in based on the content-related information of data 322. Additionally, UI template engine 304 may determine whether the predicted affinity for content items associated with musicals is greater than or equal to a predetermined affinity threshold value. Based on determining the predicted affinity for content items associated with musicals is greater than or equal to a predetermined affinity threshold value, UI template engine 304 may determine, for the UI template, at least one of the number of groups of tiles is to be associated with the musicals.

In another example, UI template engine 304 may determine user 132 may have an affinity for a particular media platform based on the content-related information of data 22. Additionally, UI template engine 304 may determine whether the predicted affinity for the particular media platform is greater than or equal to a predetermined affinity threshold value. Based on determining the affinity for a particular media platform is greater than or equal to the predetermined affinity threshold value, UI template engine 304 may determine at least one of the number of groups of tiles specified by the UI template is to be associated with the particular media platform group type.

In other cases, UI template engine 304 may use device information of data 322 to determine, select and/or generate the UI template. In some instances, the device information in data 322 may be associated with media device 106 the user, such as user 132, is operating. As described herein, the UI template may be based on device and/or network attributes associated with media device 106. For instance, the UI template may be customized based on device and/or network attributes in order to increase the performance of the content browser UI when presented via the device and/or network associated with the device and/or network attributes. In some examples, the device information of data 322 may include information such as the device type (e.g., smartphone, television, laptop, desktop, augmented reality device, virtual reality device, mixed reality device, etc.), device resolution, device bandwidth, characteristics of a network of the device (e.g., available network bandwidth, network congestion, wireless network or wired network, throttled network or unlimited network, network connectivity or connectivity strength, cellular network or local area network, network latency, quality of service (QOS), etc.), device screen size, device performance data, device memory statistics, device storage information, and/or device profile data. UI template engine 403 may use the device information of data 322 to determine one or more aspects of the content browser UI to be specified by the UI template, such as a number of groups of tiles to include in the content browser UI (or for instances where the content browser UI includes multiple pages, a number of groups of tiles for each of the multiple pages), a number of tiles to include in each of the number of groups, and/or a layout of each of the number of groups, among other things.

By way of example, UI template engine 304 may determine, based on device information in data 322, that media device 106 has less than a threshold amount of resources (e.g., memory, processing resources, etc.) and/or an associated network has a bandwidth below a threshold. UI template engine 304 may determine aspects of the content browser UI to define in the UI template based on the device data such that the aspects of the content browser UI account for the device resources and/or network bandwidth. To illustrate, UI template engine 304 may determine a number of groups of tiles, a number of tiles to include in each group of tiles, and/or a layout of each of the groups of tiles to specify in the UI template such that the number of groups of tiles, number of tiles, and/or layout of each group minimizes network and/or computing resources of media device 106 given the capabilities of media device 106 and/or the available network bandwidth. For instance, with more available network bandwidth and/or greater capabilities of media device 106, UI template engine 304 may generate a UI template that specifies a greater number of groups of tiles to include in the content browser UI, and/or a greater number of tiles to include in each group of tiles.

As described herein, group template engine 303 can use data 322 to determine, select, and/or generate one or more group templates used to specify configuration/presentation attributes of one or more groups of content representations (e.g., tiles) in the content browser UI. In some examples, a group template associated with a group of tiles (or any other content representation) may specify one or more display attributes to be used to display (e.g., to configure the display of) the group of tiles in the content browser UI. The one or more display attributes may be determined based on portions of data 322 and may define display attributes for each tile (or other content representations) included in each of the groups of tiles and/or display attributes for each of the groups of tiles. In some instances, the display attributes may emphasize/highlight one or more tiles of each group of tiles, the group of tiles and/or otherwise dictate how to display the one or more tiles and/or the group of tiles. In some aspects, examples of the display attributes for the tiles includes, the size(s) of tiles, an aspect ratio(s) of the tiles, a height and/or width of the tiles, a rendering of the tiles in the group of tiles, an representation attribute(s) of the tiles (e.g., a color, a texture, an animation, a type of tile, a tile pattern, a tile font, a tile orientation, a number of tiles in a group, a sound or interactive sound associated with the tiles, a tile configuration, a tile arrangement, and/or any other a visual attribute). In some cases, examples of display attributes for the groups of tiles includes a size (e.g., height, length, and/or width) of a grouping area of the groups of tiles, and/or a group rendering characteristic (e.g., group depicted as an album, group depicted as a grid, group depicted as a row and/or column, group depicted as a carousel, group depicted as a geometric shape), and a positioning of each of the groups of tiles.

In some examples, the display attributes may highlight or emphasize one or more tiles of each group of tiles or one or more groups of tiles by adjusting one more display attributes of the tiles (e.g., the size of the tile, the aspect ratio of the tile, a representation attribute, etc.) and/or one or more display attributes of the groups of tiles (e.g., the size of the group of tiles). Additionally, or alternatively, the display attributes may highlight or emphasize one or more groups of tiles identified to be highlighted or emphasized based on one or more aspects (e.g., display attributes) of one or more groups of tiles positioned near (e.g., adjacent to or withing a threshold proximity of) the group(s) of tiles identified. Group template engine 303 may vary (or, alternatively, match) one or more display attributes of the group(s) of tiles group(s) of tiles identified with respect to the aspects of the one or more groups of tiles positioned near the group(s) of tiles identified. The variation in aspects may highlight/emphasize to the user (e.g., user 132) the tiles included in the group(s) of tiles identified and may increase engagement of the user with the content browser UI (e.g., draw user engagement to the highlighted or emphasized group(s) of tiles).

In some aspects, group template engine 303 can determine a group(s) of tiles (or other content representations) to highlight/emphasize in the content browser UI for the user, how to highlight/emphasize the group(s) of tiles, and/or other display attributes for the group(s) of tiles based on data 322, such as information about a content browsing behavior of the user, interactions between the user and content in the content browser UI, user information, context information, device information, user metrics and/or statistics, content metrics, user preferences, user activity, etc. Group template engine 303 can then determine, select, and/or generate a group(s) template for the group(s) of tiles that highlights/emphasizes the group(s) of tiles and specifies how to highlight/emphasize the group(s) of tiles and/or any other display attributes for the group(s) of tiles. For example, group template engine 303 can determine, select, and/or generate the one or more group templates based on information about user interactions included in data 322, such as information about interactions between a user (e.g., user 132) and specific content in the content browser UI, such as one or more tiles or groups of tiles included in the content browser UI.

In some cases, group template engine 303 may use the context information in data 322 to identify one or more groups of tiles to emphasize or highlight in the content browser UI and/or to determine, select and/or generate the one or more group templates for the identified groups of tiles. As described herein, the context information can include information about each content group (e.g., tiles) displayed in the content browser UI and/or available for display in the content browser UI. In some instances, the context information about each content group may include time/date information indicating, for any group of tiles displayed by the content browser UI or any interface (e.g., page) of the content browser UI, a time/date of each instance the user interacted with a content group such as a group of tiles (e.g., selecting a tile of the group of tiles, scrolling through the group of tiles, etc.), duration information indicating a time duration of each time the user interacted with the group of tiles, positioning information indicating a position of the group of tiles displayed on the content browser UI or any interface of the content browser UI, demographic information associated with the user, language information associated with the user (e.g., a language preference of the user) and/or age information associated with the user.

For instance, based on the context information associated with each content group (e.g., time/date information, duration information, etc.), group template engine 303 may determine, for any group of tiles of the content browser UI, a number of instances or interactions user 132 interacted with the group of tiles, a total time duration user 132 interacted with the group of tiles, and/or a quality of interaction (e.g., positive or negative). Based on such determination, group template engine 303 may identify one or more groups of tiles that have a number of interactions greater than or equal to a predetermined threshold interaction number and/or a total interaction duration time greater than or equal to a predetermined threshold interaction duration time. In some instance, and as described herein, UI template engine 304 may use one or more AI/ML models/algorithms to make such determinations based on the context information associated with each content group, and identify the one or more groups of tiles based on such determinations. For each of the identified one or more groups of tiles, group template engine 303 may determine, select, and/or generate a group template. The group template associated with a group of tiles (or any other content representation) may specify one or more visual attributes to be used when displaying the group of tiles in the content browser UI, as previously explained. The one or more visual attributes may be determined based on data 322 and may include any attributes used to emphasize/highlight the group of tiles and/or otherwise dictate how to display the group of tiles.

In some instances, group template engine 303 may determine the one or more group templates for the one or more groups of tiles identified by selecting the one or more group templates from a set of predetermined group templates. A group template(s) from the set of predetermined group templates may specify or define one or more display attributes for each tile of the one or more groups of tiles identified and/or each group of tiles from the one or more groups of tiles identified. For example, the set of predetermined group templates (or a subset thereof) may specify or define one or more display attributes for the group(s) of tiles identified.

In another instance, the context information of data 322 may identify one or more display attributes of one or more groups of tiles, such as a positioning information of a corresponding group of tiles indicating a position of the group of tiles on the content browser UI (or an interface of the content browser UI) for displaying the group(s) of tiles identified (and/or the tiles in the group(s) of tiles identified). In such an instance, group template engine 303 may use the positioning information to determine a different position for the groups of tiles on content browser UI (or an interface of the content browser UI). For instance, when the user accesses the content browser UI at a first instance, an identified group of tiles may be positioned on the bottom half of the content browser UI. Based on positioning information determined from data 322, group template engine 303 may determine that the identified group of tiles is positioned on the bottom half of the content browser UI. Moreover, based on the positioning information in data 322, and in some instances, other context information in data 322, such as time/date information, duration information, and/or other context information, group template engine 303 may select or generate a group template for the identified group of tiles that specifies a different positioning for the identified group of tiles (e.g., on the top half of the content browser UI).

In an example, group template engine 303 may determine user 132 prefers a language, such as French, based on language information (e.g., language information included in data 322 or language information included in account data from data 322) associated with the user. UI template engine 403 may identify a group of tiles associated with the content browser UI that includes tiles representing content that is in the preferred language (either dubbed or originally) and/or have subtitles in that preferred language. Group template engine 303 may determine, select and/or generate a group template specifying one or more display attributes to be used by the content browser UI to display the group of tiles associated with the preferred language. The group template may emphasize or highlight the identified group of tiles.

In yet another example, group template engine 303 may determine or generate the group template for the identified group of tiles based on age information of a user, such as user 132. For instance, group template engine 303 may identify a group of tiles to be emphasized/highlighted and may determine a display attribute for the tiles in the group of tiles identified based on the age information. Group template engine 303 can then determine, select, and/or generate a group template for the group of tiles identified that specifies or defines the display attribute to be used when displaying the group of tiles identified. For example, if user 132 is older than a predetermined age, group template engine 303 may select or generate a group template that specifies a size above a threshold and/or a threshold aspect ratio for tiles of the identified group of tiles since users who are older than the predetermined age may have difficulty viewing smaller tiles. On the other hand, if user 132 is younger than the predetermined age, group template engine 303 may instead select or generate a group template that specifies a smaller size and/or aspect ratio for tiles of the identified group of tiles since users who are younger than the predetermined age may have less difficulty viewing smaller tiles. In some instances, group template engine 303 may use one or more one or more AI/ML models/algorithms to determine the age of user 132 based on one or more portions of data 320 or data 322 and, in some instances, select or generate a group template corresponding to the determined age of user 132.

In some cases, group template engine 303 may use affinity data to identify one or more groups of tiles to emphasize or highlight in the content browser UI and/or to determine, select, and/or generate one or more group templates for the one or more groups of tiles identified. In some examples, the affinity data may identify a content genre affinity of the user (e.g., user 132), a media type affinity (e.g., movie, television, podcast, music, livestream, etc.) of the user, a media platform/application (e.g., media streaming service or channel) affinity of the user, and/or other affinity data.

By way of example, each group of tiles displayed on an interface (e.g., page) of the content browser UI may be associated with a particular genre (e.g., action and adventure, anime, children/family, classics, comedies, documentaries, dramas, horror, music, musical, romantic, science fiction, fantasy, sports, thrillers, television (TV) Shows). Group template engine 303 may determine a genre affinity of user 132 for each group of tiles displayed on each interface based on the affinity data. In some instances, group template engine 303 may determine a value representing the genre affinity of user 132 for each group of tiles displayed on each interface based on the affinity data. Based on the genre affinity of user 132 of each group of tiles, group template engine 303 may identify one or more groups of tiles that have a genre affinity (e.g., a corresponding value) greater than or equal to a threshold genre affinity (e.g., a corresponding value). For each of the identified groups of tiles that have a genre affinity greater than or equal to a threshold genre affinity, group template engine 303 may determine or generate the group templates that specify one or more display attributes to be used by the content browser UI to display the group of tiles. The group templates may emphasizes or highlights the identified groups of tiles.

In another example, each group of tiles displayed on an interface (e.g., page) of the content browser UI may be associated with a particular media type (e.g., movie, television show, podcast, music, and livestream or live). Group template engine 303 may determine a media type affinity of user 132 for each group of tiles displayed on each interface based on the affinity data. In some instances, group template engine 303 may determine a value representing the media type affinity of user 132 for each group of tiles displayed on each interface based on the affinity data. Based on the media type affinity of user 132 of each group of tiles, group template engine 303 may identify one or more groups of tiles that have a media type affinity (e.g., a corresponding value) greater than or equal to a predetermined threshold media type affinity (e.g., a corresponding value). For each of the identified groups of tiles, group template engine 303 may determine, select, and/or generate a respective group template that customizes the display of each respective group of tiles. For example, the group templates may modify how the identified group of tiles to emphasize or highlight the identified groups of tiles.

In another example, each group of tiles displayed on an interface (e.g., page) of the content browser UI may be associated with a particular media platform or media application (e.g., media streaming service or channel). Group template engine 303 may determine a media application affinity of user 132 for each group of tiles displayed on each interface based on the affinity data. In some instances, group template engine 303 may determine a value representing the media application affinity of user 132 for each group of tiles displayed on each interface based on the affinity data. Based on the media application affinity of user 132 of each group of tiles, group template engine 303 may identify one or more groups of tiles that have a media application affinity (e.g., a corresponding value) greater than or equal to a predetermined threshold media application affinity (e.g., a corresponding value). For each of the identified groups of tiles, group template engine 303 may determine, select, and/or generate the group templates. The group templates may emphasize or highlight the identified groups of tiles.

In some instances, group template engine 303 may determine, select, and/or generate the group templates for one or more groups of tiles based on the release date of each of the tiles included in each of the groups of tiles. For instance, a group of tiles displayed by a content browser UI may be associated with an action and adventure genre and a movie media type. Based on data indicating that the group of tiles is associated with an action and adventure genre and a movie media type, group template engine 303 may determine a release date associated with each content represented by each tile of the group of tiles. In some cases, based on the determine release date associated with each tile of the group of tiles, group template engine 303 may identify one or more tiles of the group of tiles with an associated release date that is within a predetermined date range threshold to a particular time and/or date (e.g., current time and date). Group template engine 303 may determine, generate or select a group template for each of the identified tiles. For instance, the selected, determined or generated group template may define a display attribute of the identified tiles to highlight or emphasize the identified tiles. In some instances, the group template may position or reposition the identified tiles to an upfront position (e.g., to the very left of a group of tiles in a row layout or to the very top of a group of tiles in a column layout). In other instances, the group template may specify an aspect ratio or size for the identified tiles (e.g., a small size and/or aspect ratio or a large size and/or aspect ratio).

In some instances, data 322 may indicate a time-sensitivity (e.g., live stream or will be removed within a certain amount of time or a certain date) for one or more content items. In such instances, group template engine 303 may determine, select, and/or generate the group templates that define display attribute(s) for the tiles of the time-sensitive content items to highlight or emphasize the tiles of the time-sensitive content items. For instance, a content browser UI may include a plurality of groups of tiles. The plurality of groups of tiles may include a first group of tiles associated with a movie media type and a second group of tiles associated with livestream media type. Based on the indication in data 322 that the one or more content items are time-sensitive, group template engine 303 may determine one or more content items of tiles included in the second group of tiles is about to start or about to end based on the current time and date. Moreover, group template engine 303 may determine, generate or select a group template for the tiles of the second group of tiles determined to be starting soon or ending soon (e.g., within a threshold period of time or within a certain date). For instance, the selected, determined or generated group template may highlight or emphasize the tiles as described herein.

In various instances, the group content related data may identify an affinity of each content item of multimedia environment 102 based on interactions of users of multimedia environment 102 (e.g., trending content items such as content items having a threshold amount of user activity (e.g., playback) or having a threshold rank or popularity, etc.). In such instances, group template engine 303 may determine, select, and/or generate the group templates that define display attribute(s) for the tiles of the trending content items to emphasize or highlight the tiles of the trending content items. For instance, a content browser UI may include a plurality of groups of tiles. The plurality of groups of tiles may include a first group of tiles associated with a movie media type and a second group of tiles associated with television show media type. Based on the group content related data, group template engine 303 may identify tiles of content items included in the first group of tiles that is trending. Moreover, group template engine 303 may determine, generate or select a group template for the identified tiles. For instance, the selected, determined or generated group template may highlight or emphasize the identified tiles as described herein.

In various cases, group template engine 303 may use device data of media device 106 (e.g., included in data 322) to determine, select, and/or generate the group templates for the identified groups of tiles. As described herein, group template engine 303 may use device and/or network attributes associated with media device 106 (e.g., included in data 322) to generate group templates for the identified groups of tiles to increase the performance of the content browser UI (e.g., by selecting to display tiles of less than a threshold size in association with the content items corresponding to the identified groups of tiles and/or by compressing such tiles in a certain way). In some examples, the device data in data 322 may include information such as the device type (e.g., smartphone, television, laptop, desktop, augmented reality device, virtual reality device, mixed reality device, etc.), device resolution, device bandwidth, characteristics of a network of the device (e.g., available network bandwidth, network congestion, wireless network or wired network, throttled network or unlimited network, network connectivity or connectivity strength, cellular network or local area network, network latency, quality of service (QOS), etc.), device screen size, device performance data, device memory statistics, device storage information, and/or device profile data.

By way of example, group template engine 303 may determine media device 106 has less than a threshold amount of resources (e.g., memory, processing resources, etc.) and/or an associated network has a bandwidth below a threshold, based on the device data in data 322. Group template engine 303 may identify one or more groups of tiles of an interface of a content browser UI based on the device data as described herein. Moreover, group template engine 303 may determine, generate or select group templates for the identified groups of tiles that minimizes network and/or computing resources of media device 106 given the capabilities of media device 106 and/or the available network bandwidth. For instance, for media device 106 or network has a bandwidth below a threshold and/or media device 106 has less than a threshold amount of device resources (e.g., memory, processing resources, etc.), group template engine 303 may select group templates that define tiles of the identified groups of tiles that are modified or configured to reduce the amount of network and/or device resources used by such tiles, such as tiles that are smaller in size or of a lower pixel quality.

In some cases, group template engine 303 may use search information in data 322 to identify the groups of tiles and/or determine or generate the group templates for the identified groups of tiles. The search information may be associated with the user searching for content items. By way of example, a content browser UI may include groups of tiles including a first group of tiles associated with an action and adventure genre, a second group of tiles associated with a horror genre, and a third group of tiles associated with a documentary genre. Group template engine 303 may determine user 132 is searching for content related to documentaries based on the search information. Moreover, group template engine 303 may identify the third group of tiles as the group of tiles to highlight or emphasize based on determining user 132 is searching for content related to documentaries. Further, group template engine 303 may determine, generate or select group templates for the identified third group of tiles. For instance, the selected, determined or generated group templates may highlight or emphasize the tiles of the identified third group of tiles as described herein.

In various cases, search information may include discovery information indicating a time duration associated with a user, such as user 132 scrolling or navigating the content browser UI and finding a content item that is played. UI template engine 304 and/or group template engine 303 may use the discovery information to update the UI template or group template(s). By way of example, UI template engine 304 may determine that the duration of time (e.g., a corresponding value) user 132 scrolls, navigates or searches for content that user 132 eventually plays is greater than or equal to a time threshold (e.g., a corresponding value). Additionally, based on such a determination, UI template engine 304 may determine, search or generate a UI template that may reduce the duration of time user 132 may take to scroll, navigate or search for content that user 132 will eventually play. For instance, the UI template that UI template engine 304 generates may reduce the number of groups of tiles for the content browser UI and/or increases the number of tiles to be included in each of the groups of tiles of content browser UI. Additionally, or alternatively, group template engine 303 may determine that the duration of time (e.g., a corresponding value) user 132 scrolls, navigates or searches for content that user 132 eventually plays is greater than or equal to a time threshold (e.g., a corresponding value). Additionally, based on such a determination, group template engine 303 may determine, search or generate one or more group templates that may reduce the duration of time user 132 may take to scroll, navigate or search for content that user 132 will eventually play. For instance, the group template that group template engine 303 generates may increase the size and/or aspect ratio of the tiles of one or more groups of tiles.

In other cases, the groups of tiles may be dynamic while a user is interacting with the content browser UI. In some instances, the content browser UI may expand a group of tiles, such as a row of tiles, when user is interacting with the group of tiles (e.g., scrolling within the group of tiles). The expanded group of tiles my include more tiles that that was originally included in the group of tiles before the expansion, and may present to the user more content item options to select from and/or other actions the user may perform (e.g., search, start a subscription, video preview of a tile, etc.). In other instances, a user may be scrolling through the content browser UI. In such instances, if the user ends up not interacting with any of the groups of tiles, content browser UI may display groups of tiles that combine group types or categories that may be of interest of the user.

As described herein, recommendation system 310 may include layout engine 305. Layout engine 305 can be used by recommendation system 310 to configure the content browser UI based on the UI template and/or the one or more group templates. In some examples, layout engine 305 may configure the content browser based on the UI template and/or the group templates by incorporating or applying the UI template and/or group templates to the content browser UI. In some instances, layout engine 305 may generate updated interface data 330 based on the UI template and/or the one or more group templates. Updated interface data 330 can include or apply one or more portions of UI template and/or one or more portions of group template. For example, layout engine 305 may utilize the UI template to configure aspects of the content browser UI (e.g., number of groups of tiles, the number of tiles of each of the number of groups of tiles, the layout of each of the number of groups of tiles, etc.). Moreover, layout engine 305 may utilize group template(s) to configure aspects of corresponding groups of tiles on content browser UI (e.g., display attributes for each tile included in each of the groups of tiles and/or display attributes for each of the groups of tiles.)

Layout engine 305 (and/or recommendation system 310) may provide updated interface data 330 to media device 106. Moreover, media device 106 may apply the UI template and/or the group templates to content browser UI. Further, media device 106 may display or present content browser UI in accordance with the UI template and/or group templates. In other instances, layout engine 305 may apply the UI template and/or group templates to the content browser UI. In some examples, layout engine 305 may generate updated interface data 330 that includes one or more portions of the content browser UI with the applied UI template and/or group templates. Further, media device 106 may, based on updated interface data 330, display or present content browser UI in accordance with updated interface data 330. For example, media device 106 may utilize the UI template and/or group template(s) to configure content browser UI. In some aspects, media device 106 may utilize to UI template to configure the content browser UI as whole in accordance with the UI template (e.g., a number of groups of tiles to include in content browser UI, a category/group type associated with each of the number of groups of tiles, a number of tiles to include for each of the number of groups of tiles, the layout of each of the number of groups of tiles, the overall layout of the content browser UI, the display arrangement for the groups of tiles, the order for displaying groups of tiles and/or tiles in groups of tiles, etc.). In some cases, media device 106 may utilize the group template(s) to configure group(s) of tiles identified in the group template(s) (e.g., display attributes of the tiles, such as the size, aspect ratio etc., and/or the display attributes of the identified group(s) of tiles, such as the size).

In some examples, recommendation system 310 may include content engine 306. Content engine 306 may obtain representation attribute(s) for the tiles in one or more groups of tiles of content browser UI (e.g., a color, a texture, an animation, a type of tile, a tile pattern, a tile font, a tile orientation, a number of tiles in a group, a sound or interactive sound associated with the tiles, a tile configuration, a tile arrangement, and/or any other a visual attribute). In such examples, the representation attribute(s) for the tiles in the group of tiles may be specified by one or more associated group templates. As described herein, media device 106 may display the representation attribute(s) on a corresponding content browser UI with the associated tiles. In some cases, UI engine 302 may provide such representation attribute(s) to media device 106 and media device 106 may display the obtained representation attributes on a content browser UI along with the associated tiles.

In other examples, UI engine 302, group template engine 303 and/or UI template engine 304 may update a content browser UI that a user, such as user 132, may have been interacting with. In some instances, group template engine 303 may update one or more group templates of one or more groups of tiles of content browser UI or an interface (e.g., page) of content browser UI. In such instances, group template engine 303 may use data 322 to update the group templates of the groups of tiles. In some cases, one or more portions of data 322 associated with interactions between the user and the group of tiles, group context data, group content related information, affinity information, device information and/or search information used to update the group templates of the groups of tiles may be associated with a previous or most recent time the user accessed the content browser UI.

In various instances, group template engine 303 may use portions of data 322 to deemphasize a highlighted or emphasized group of tiles. For instance, based on the portions of data 322, group template engine 303 may determine a group of tiles may be deemphasized. The portions of data 322 may indicate the group of tiles may no longer increase engagement of user 132 of the content browser UI or engagement of the group of tiles is below a threshold engagement value. Further, group template engine 303 may determine, select, and/or generate one or more group templates for the group of tiles to deemphasize the group of tiles (e.g., make the group of tiles more uniform, monotonous, and/or visually less distinctive with respect to neighboring groups of tiles). The content browser UI may display the various groups of tiles in accordance with the corresponding group templates where the group of tiles noted above is now deemphasized.

In some cases, group template engine 303 may obtain group engagement data (e.g., included in data 322) indicating for a content browser UI that was accessed during a first instance, user 132 did not interact with a subgroup of tiles of a first group of tiles. Group template engine 303 may update a corresponding group template associated based on the engagement data. For instances, group template engine 303 may generate or determine new group templates for the first group of tiles that adjusts the display attributes of the first group of tiles or the display attributes of the tiles of the first group of tiles (e.g., adding different tiles or more tiles into the first group or select).

In some examples, UI template engine 304 may use portions of data 322 associated with user 132 accessing and interacting with the content browser UI during a first time interval. Moreover, aspects of the content browser UI may be defined by a first UI template. Based on the portions of data 322, UI template engine 304 may determine or generate a new UI template. Further, layout engine 305 may apply the new UI template to content browser UI. The content browser UI may display groups of tiles in accordance with the new UI template different from the first UI template (e.g., different number of groups of tiles, different number of tiles in the groups of tiles, and/or different group types or categories for the groups of tiles and different layouts).

In various instances, UI engine 302 may use engagement data (e.g., included in data 322) of the user, such as user 132, to determine when to update the content browser UI or an interface (e.g., page) of content browser UI. UI engine 302, group template engine 303 and/or UI template engine 304 may determine how frequently user 132 may access content browser UI, a duration of time of user 132 interacts with the content browser UI each time user 132 accesses content browser UI, the average duration of time user 132 interacts with content browser UI each time user 132 accesses the content browser UI, and/or time user 132 access content browser UI on average based on the engagement data. Based on such determinations, group template engine 303 and/or UI template engine 304 may determine when to update the group templates and/or UI templates, respectively.

By way of example, group template engine 303 may determine engagement data based on portions of data 322 associated with interactions between user 132 and group of tiles of a content browser UI. Based on the engagement data, group template engine 303 may determine user 132 accesses the content browser UI daily. Based on determining user 132 accesses the content browser UI daily, group template engine 303 may obtain portions of data 322 daily. Moreover, based on the portions of data 322 associated with interactions between user 132 and group of tiles of a content browser UI, corresponding group context data, corresponding group content related data, device data and/or search data, group template engine 303 may determine or generate group templates or update the group templates of one or more groups of tiles of content browser UI.

In another example, UI template engine 304 may determine engagement data based on portions of data 322 associated with interactions between the user and the content browser UI. Based on the engagement data, UI template engine 304 may determine user 132 accesses the content browser UI weekly. Based on determining user 132 accesses the content browser UI weekly, UI template engine 304 may obtain portions of data 322 weekly. Moreover, based on the portions of data 322 UI template engine 304 may determine or generate a UI template or update the UI template for content browser UI. Alternatively, in some instances, UI template engine 304 may periodically update the UI template of content browser UI, such as monthly. To avoid user confusion or frustration with content browser UI constantly changing, UI template engine 304 may periodically update the UI template of content browser UI less frequently (e.g., bimonthly, quarterly, etc.).

In some instances, UI engine 302 may determine or generate one or more group templates for one or more groups of tiles of a content browser UI after a UI template for the content browser UI has been determined or generated. For example, at a first instance, UI template engine 304 may generate a UI template for a content browser UI based on portions of data 322. UI template may specify the content browser UI includes a first group of tiles associated with an action and adventure genre and movie media type, a second group of tiles associated with a documentary genre and television media type, a third group of tiles associated with a sports genre and livestream media type, and a fourth group of tiles associated with a particular media application or platform. Moreover, at a second instance, group template engine 303 may obtain portions of data 322 associated with interactions between user 132 and each of the group of tiles identified in the UI template (e.g., the first group of tiles, the second group of tiles, the third group of tiles and the fourth group of tiles). Based on the portions of data 322 associated with interactions between user 132 and each of the group of tiles identified in the UI template, group template engine 303 may identify the second group of tiles and the fourth group of tiles as the tiles to highlight or emphasize. As described herein, the identified groups of tiles may increase over engagement of user 132 with the content browser UI. Further, based on portions of the data 322 associated with interactions between user 132 and each of the group of tiles identified in the UI template (e.g., the first group of tiles, the second group of tiles, the third group of tiles and the fourth group of tiles), group template engine 303 may determine or generate one or more group templates for the identified second group of tiles and the fourth group of tiles. As described herein, the group templates may emphasize or highlight the second group of tiles and the fourth group of tiles.

In some instances, UI engine 302 may determine or generate a UI template for a content browser UI after one or more group templates for one or more groups of tiles of the content browser UI has been determined or generated. For example, at a first instance, group template engine 303 may generate group templates for a content browser UI based on portions of data 322. The content browser UI may be defined by a UI template that specifies the content browser UI may include a first group of tiles associated with an action and adventure genre and movie media type, a second group of tiles associated with a documentary genre and television media type, a third group of tiles associated with a sports genre and livestream media type, and a fourth group of tiles associated with a particular media application or platform. Moreover, at a second instance, group template engine 303 may obtain portions of data 322 associated with interactions between user 132 and the content browser UI as a whole, engagement data, account data, context data, content related data and/or device data. Based on the portions of data 322, UI template engine 304 may generate or determine a UI template or an update to the UI template of the content browser UI. As described herein, layout engine 305 may apply the determined UI template or the update to the UI template of the content browser UI.

In various instances, UI engine 302 may combine different UI templates or different group templates. In some cases, the different UI templates and different group templates may each be associated with a different content browser UI of different users or a particular user, such as user 132. In various cases, the different UI templates or different group templates may be associated with metric data indicating a performance value over a threshold performance value. For instance, the different UI templates may each be associated with metric data indicating the number of content items played for at least a predetermined amount of time is greater than a predetermined number of content items played for at least a predetermined amount of time. In such an instance, UI engine 302 and/or layout engine 305 may combine the different UI templates (e.g., the two best performing UI templates). In another instance, the different group templates may each be associated with metric data indicating a corresponding CTR is greater than a predetermined CTR threshold. In such an instance, UI engine 302 and/or layout engine 305 may combine the different group templates (e.g., the two best performing group templates). In some instances, UI engine 302 may discard UI templates and/or group templates that did not perform well. For instance, UI engine 302 may determine one or more UI templates and/or group templates may be associated with metric data indicating a performance value below a threshold performance value. Additionally, UI engine 302 may discard the UI templates and/or group templates that were determined to be associated with metric data indicating a performance value below the threshold performance value.

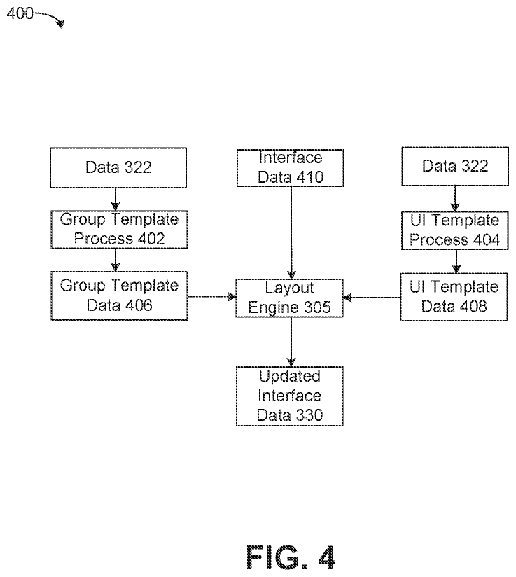

FIG. 4 is a diagram illustrating an example system process 400 for customizing/personalizing content browser UIs, according to some examples of the present disclosure. In this example, system process 400 may include group template process 402 and UI template process 404. Group template process 402 may be by group template engine 303 and UI template process 404 may be by UI template engine 304.

In some cases, UI template process 404 may include determining or generating the UI template for the content browser UI based on portions of data 322. Moreover, UI template process 404 may include updating the UI template or determining updates for the UI template based on portions of data 322.

In other cases, group template process 402 may include determining the group templates for the content browser UI based on portions of data 322. Moreover, group template process 402 may include determining new groups of tiles to be emphasized or highlighted, groups of tiles of the content browser UI to be deemphasized, and/or updates for the group of templates based on portions of data 322.

Layout engine 305 may apply the UI template, the updates to the UI template (or the updated UI template), the group templates, and/or the updates to the group templates or (updated group template) to the content browser UI. In some instances, layout engine 305 may obtain interface data 410 identifying and/or characterizing a current UI template and/or group templates. In some cases, interface data 410 may be stored and updated by layout engine 305 each time a UI template, the updates to the UI template (or the updated UI template), the group templates, and/or the updates to the group templates or (updated UI template) are applied to the content browser UI. Layout engine 305 may obtain group template data 406 from group template process 402. As described herein, group template data 406 may identify and characterize the group templates, the updates to the group templates or updated group templates. Moreover, layout engine 305 may obtain UI template data 408 from UI template process 404. As described herein, UI template data 408 may identify and characterize the UI template, the updates to the UI template or updated UI template.

In some cases, layout engine 205 may generate updated interface data 330. Updated interface data 330 can include one or more portions of UI template data 408 and/or one or more portions of group template data 406. Layout engine 205 may provide updated interface data 330 to media device 106. Media device 106 may apply the UI template (or updates to the UI template or updated UI template) of the portions of UI template data and/or the group templates (or updates to the group template or updated group template) of the portions of group template data to content browser UI. In other cases, may apply the UI template, the updates to the UI template (or the updated UI template), the group templates, and the updates to the group templates or (updated UI template) of UI template data 408 and group template data 406 respectively to the content browser UI. In some examples, updated interface data 330 can include one or more portions of the content browser UI with the applied UI template (or the updated UI template or updated UI template) and/or group templates (or the updated group templates or updated group templates). Layout engine 305 may provide updated interface data 330 to media device 106. Media device 106 may, based on updated interface data 330, display or present content browser UI in accordance with the UI template (or the updated UI template or updated UI template) and group templates (or the updated group templates or updated group templates).

In some instances, group template process 402 may be a trained AI/ML process configured to determine one or more group templates for one or more groups of tiles of a content browser UI or an interface (e.g., page) of the content browser UI. Group template engine 303 may use group template process 402 to determine or generate the group templates. In some cases, the trained AI/ML process of group template process 402 may be an exploration and exploitation model, such as an upper confidence bound process. In some cases, the trained AI/ML process of group template process 402 may be retrained. In such cases, metric data associated with the content browser UI may be used to retrain or update the trained AI/ML process of group template process 402. As described herein, the metric data may be associated with the identified groups of tiles of content browser UI that were highlighted or emphasized by the determined or generated group templates. Group template engine 303 may determine such metric data, based on data 322 and the identified groups of tiles. Further, the metric data may indicate a performance of the identified groups of tiles. In some instances, the performance of the identified groups of tiles may be measured by a click through rate. Referring to FIG. 3, group template engine 303 may retrain or update the trained AI/ML process of group template process 402 based on the click through rate.

In various cases, group template engine 303 may retrain or update the trained AI/ML process of group template process 402 by determining whether the metric data, such as the click through rate, satisfies a performance threshold condition, such as a minimum click through rate. For example, group template engine 303 may determine the click through rate for the groups of tiles that were highlighted or emphasized is less than a minimum click through rate. In such examples, group template engine 303 may adjust one or more process parameters of the trained AI/ML process of group template process 402 until a corresponding click through rate of subsequently generated or determined group templates satisfies the minimum click through rate.

In some instances, UI template process 404 may be a trained AI/ML process configured to determine a UI template for a content browser UI. UI template engine 304 may utilize UI template process 404 to determine or generate the group templates. In some cases, the trained AI/ML process of UI template process 404 may be an exploration and exploitation model, such as a linear upper confidence bound process. In some cases, the trained AI/ML process of UI template process 404 may be retrained. In such cases, metric data associated with the content browser UI may be used to retrain or update the trained AI/ML process of UI template process 404. As described herein, the metric data may be associated with the groups of tiles of content browser UI. Further, the metric data may indicate a performance of the content browser UI as a whole. In some instances, the performance of the content browser UI may be measured by whether content items of groups of tiles included in the content browser UI are being played for more than or equal to a threshold amount of time. Referring to FIG. 3, UI template engine 304 may retrain or update the trained AI/ML process of UI template process 404 based on the such metric data.

In various cases, UI template engine 304 may retrain or update the trained AI/ML process of UI template process 404 by determining whether the metric data, such as metric data characterizing whether content items of groups of tiles included in the content browser UI are being played for more than or equal to a threshold amount of time, satisfies a performance threshold condition, such as a minimum number of content items that are played for more than or equal to a threshold amount of time. For example, UI template engine 304 may determine the number of content items of content browser UI that have been played for more than or equal to a threshold amount of time is less than a minimum number of content items that are played for more than or equal to a threshold amount of time. In such examples, UI template engine 304 may adjust one or more process parameters of the trained AI/ML process of UI template process 404 until a number of content items that are played for at least a threshold amount of time satisfy the minimum number of content items that are played for more than or equal to a threshold amount of time.

In various instances, group template engine 303 and/or UI template engine 304 may use engagement data of the user, such as user 132, to determine when to retrain or update the trained AI/ML process of group template process 402 and/or the trained AI/ML process of UI template process 404, respectively. In such instances, group template engine 303 and/or UI template engine 304 may determine engagement data based on corresponding portions of data 322.

By way of example, based on the engagement data, group template engine 303 may determine user 132 accesses the content browser UI daily. Group template engine 303 may obtain portions of data 322 associated with interactions between user 132 and the highlighted or emphasized group of tiles on a periodic basis (e.g., daily, weekly, monthly, etc.). Moreover, for each period (e.g., day, week, month, etc.), group template engine 303 may generate metric data that includes portions characterizing a click through rate for the highlighted or emphasized group of tiles and determine whether the metric data satisfies a performance threshold condition, such as a minimum click through rate. In instances where group template engine 303 determines the metric data does not satisfy the performance threshold condition, group template engine 303 may retrain or update the trained AI/ML process of group template process 402.

In another example, UI template engine 304 may generate metric data that includes portions characterizing instances user 132 played content items for at least a predetermined amount of time. UI template engine 304 may determine whether the metric data satisfies a performance threshold condition, such as a minimum number of instances the user played a content item for at least a predetermined amount of time. In instances where group template engine 303 determines the metric data does not satisfy the performance threshold condition, group template engine 303 may retrain or update the trained AI/ML process of UI template process 404.

In some examples, a content browser UI rendered based on a UI template and/or group templates may be treated as an image. The image may depict the layout or configuration of the content browser UI. In such examples, a trained AI/ML process, such as a Generative Adversarial Network (GAN), diffusion, and/or convolutional neural network based process associated with object detection, may process the image to generate or determine a UI template (or update) and/or one or more group templates (or update) for the content browser UI. The trained AI/ML process may utilize data 322 to generate or determine the UI template (or update) and/or the group templates (or update) for the content browser UI. As described herein, the UI template and/or the group templates determined or generated by the trained AI/ML process may intelligently highlight/emphasize content of interest to a user in a content browser UI, increase the configuration variety/diversity of the content browser UI and take into account for device attributes and/or network attributes of media device 106 in order to increase the performance of the content browser UI.

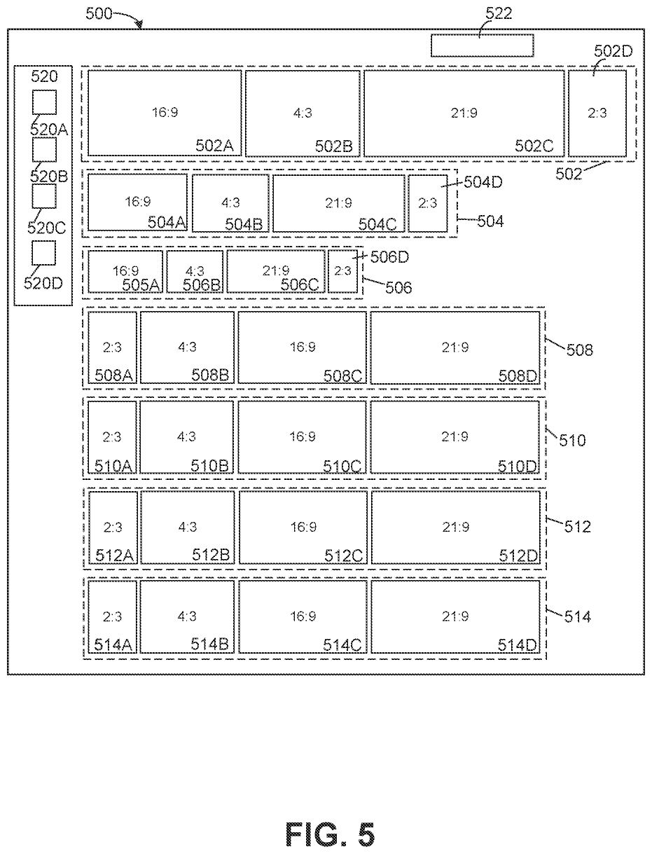

FIG. 5 is a diagram illustrating an example content browser UI 500 generated using a UI template and one or more group templates, according to some examples of the present disclosure. As described herein, a UI template may be applied to content browser UI 500. UI template may define aspects of content browser UI 500 as a whole, such as a number of groups of tiles to include in content browser UI 500 (or for each interface (e.g., page) included in content browser UI 500), a group type or category for each of the number of groups of tiles, a number of tiles to include in each of the number of groups, a layout for each of the number of groups, an arrangement of each of the groups (e.g., row, column, grid, etc.), among others. For example, and as illustrated in FIG. 5, the UI template may identify seven groups of tiles, such as group of tiles 502, group of tiles 504, group of tiles 506, group of tiles 508, group of tiles 510, group of tiles 512, and group of tiles 514. UI template may identify a group type/category and/or media type associated with each of the seven groups of tiles. For example, group of tiles 502 may be associated with sports and live streams, group of tiles 504 may be associated with documentaries and movies, group of tiles 506 may be associated with anime and television shows, group of tiles 508 may be associated with horror and movies, group of tiles 510 may be associated with comedy and television shows, group of tiles 512 may be associated with comedy and movies, and group of tiles 514 may be associated with science fiction and movies. Moreover, UI template may indicate that each of the seven groups of tiles is to include four tiles and each of the seven groups of tiles is to be in a row layout.

Moreover, one or more group templates may be applied to content browser UI 500 and may define aspects of one or more of the groups of tiles of content browser UI 500, such as one or more groups of tiles to emphasize or highlight, the size of the tiles in the groups of tiles, the aspect ratios of the tiles in the group of tiles, a height and/or width of the tiles in the group of tiles, a display attribute of the groups of tiles, etc. For example, the group templates may identify group of tiles 502, group of tiles 504 and group of tiles 506 as the groups of tiles to be emphasized and highlighted. The group templates may indicate aspects of the identified groups of tiles (e.g., the size of the tiles in the groups of tiles, the aspect ratios of the tiles in the group of tiles, a height and/or width of the tiles in the group of tiles, display attribute of the groups of tiles, etc.). As illustrated in FIG. 5, the size, aspect ratios and even the row height of group of tiles 502, group of tiles 504 and group of tiles 506 are varied, while the aspects of group of tiles 508, group of tiles 510, group of tiles 512, and group of tiles 514 are similar or the same.

In some instances, content browser UI 500 may include additional UI elements, such as UI elements associated with different other interfaces (e.g., pages) and UI elements associated with additional options for content browser UI 500. As illustrated in FIG. 5, content browser UI 500 may include side bar element 520 that includes multiple UI elements, such as UI element 520A, UI element 520B, UI element 520C and UI element 520D. In some cases, each of the multiple UI elements may be associated with a different interface (e.g., page). For instance, UI element 520A may be associated with a home interface, UI element 520A may be associated with a recommendations interface, UI element 520B may be associated with live streaming, UI element 520C may be associated with different media platforms or media applications, and UI element 520D may be associated with a setting interface. Content browser UI 500 may include UI element 522 that when selected or triggered may enable a user, such as user 132, to access an options interface or menu.

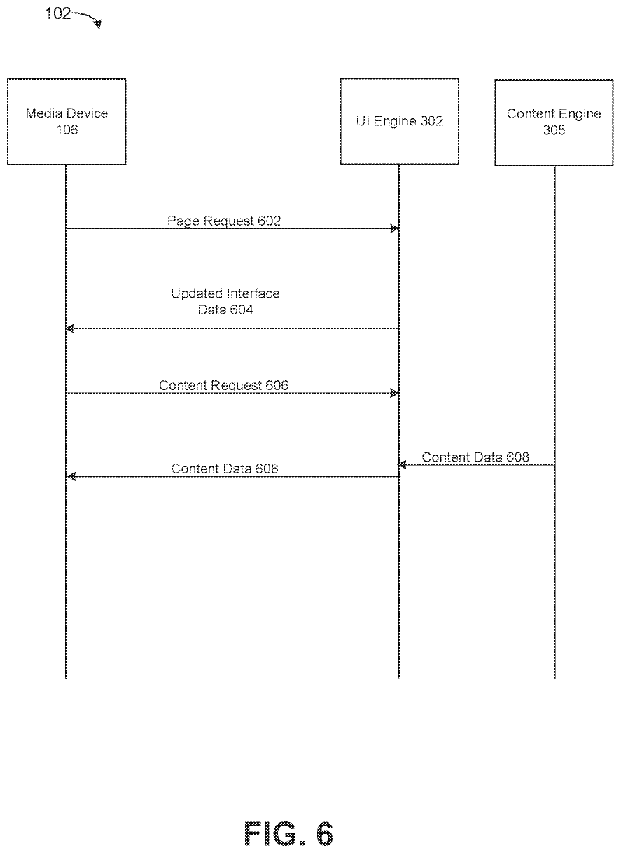

In some examples, media device 106 may obtain a UI template and/or group templates for a content browser UI, such as content browser UI 500 of FIG. 5 in response to a page request. Referring to FIG. 6, media device 106 may generate and transmit page request 602 to UI engine 302 of recommendation system 310. In some instances, media device 106 may provide page request 602 to UI engine 302 when accessing content browser UI 500. UI engine 302 may perform any of the example processes described herein to determine or generate a UI template and/or one or more group templates based on page request 602.

Moreover, UI engine 302 may provide updated interface data 604 to media device 106. In some instances, updated interface data 604 may identify and characterize the UI template and/or the group templates. In such instances, one or more processors of media device 106 may apply the UI template and/or the group templates of the to the content browser UI. In other instances, updated interface data 604 may identify and characterize content browser UI with the applied the UI template and/or the group templates. In such instances, UI engine 302 may apply the UI template and/or the group templates to content browser UI and generate such updated interface data 604. Further, media device 106 may, based on updated interface data 330, display or present content browser UI in accordance with updated interface data 330.

Further, media device 106 may generate and transmit content request 606 to UI engine 302. As described herein, the content request 606 may identify each tile of each group of tiles and associated attributes. Based on content request 606, UI engine 302 may obtain the attributes of each tile of each group of tiles via content engine 306. For example, UI engine 302 may obtain, via content engine 306, an image, animation and/or a sound or interactive sound for each tile of each group of tiles in accordance with content request 606. UI engine 302 may generate content data 608 including data of the obtained attributes. Moreover, UI engine 302 may provide content data 608 to media device 106. Further, media device 106 may use updated interface data 604 and content data 608 to display content browser UI where the attribute of each tile of each group of tiles of display content browser UI is presented/displayed/outputted.

In some instances, each of media device 106 and recommendation system 310 may correspond to a distributed system. In other instances, media device 106 and recommendation system 310 may be included in a single computing system. In various instances, the functionalities of media device 106 and recommendation system 310 may be performed by a single, discrete computing system. In some cases, and as illustrated in FIG. 3, each of group template engine 303, UI template engine 304, layout engine 305, and content engine 306 may each be implemented separately. In other cases, the functionalities of each of group template engine 303, UI template engine 304, layout engine 305, and content engine 306 may be combined into or implemented by a single engine.

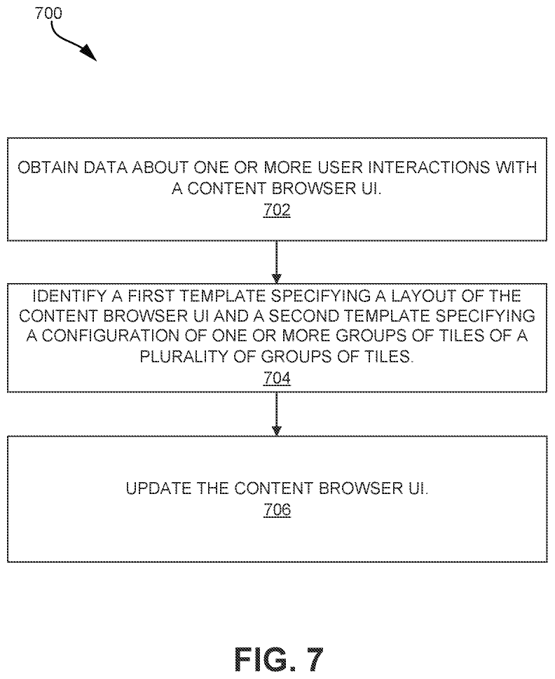

FIG. 7 is a flowchart illustrating an example method 700 for generating customized/personalized content browser UIs and browsing experiences. Method 700 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 7, as will be understood by a person of ordinary skill in the art.

Method 700 shall be described with reference to FIG. 3, FIG. 4, FIG. 5, FIG. 6 and/or FIG. 7. However, method 700 is not limited to that example. Referring to FIG. 7, at step 702, UI engine 302 may obtain data (e.g., data 322) about one or more user interactions with a content browser user interface (UI). At step 704, UI engine 302 may identify a first template (e.g., a UI template) specifying a layout of the content browser UI and a second template (e.g., a group template) specifying a configuration of one or more groups of tiles of a plurality of groups of tiles.

In some examples, group template engine 303 may use portions of the data about one or more user interactions with a content browser UI, such as portions of data 322 associated with interactions of user 132 and groups of tiles of content browser UI, to determine or generate the second template (e.g., a group template) for one or more of the plurality of groups of tiles of content browser UI. In some instances, the data used by group template engine 303 to determine/generate the second template and/or the associated group of tiles may include data about one or more user interactions with a content browser UI, group context information, group content related information, affinity information, device information, engagement information, account information, and/or search information.

In some examples, UI template engine 304 may use portions of the data about one or more user interactions with a content browser UI, such as portions of data 322 associated with interactions of user 132 and the content browser UI as a whole, to determine or generate the first template (e.g., the UI template).

At step 706, UI engine 302 may update the content browser UI based on the second template. In some examples, layout engine 305 may update the content browser UI. In some instances, layout engine 305 may generate updated interface data (e.g., updated interface data 330) that includes the first template (e.g., the UI template) and/or the second template (e.g., the group template). In some cases, the updated interface data may include additional templates, such as additional group templates for one or more additional groups of tiles (or other content representations). Layout engine 305 (or UI engine 302) may provide the updated interface data to media device 106. Media device 106 may apply the UI template and/or group templates included in the updated interface data to the content browser UI or use such templates to generate and/or render a new or updated content browser UI.

In some instances, layout engine 305 may apply the UI template and/or group templates to a content browser UI. Layout engine 305 may generate updated interface data that includes data characterizing the content browser UI with the applied UI template and/or group templates. Layout engine 305 may also provide updated interface data 330 to media device 106. Media device 106 may present or display the content browser UI in accordance with updated interface data 330.

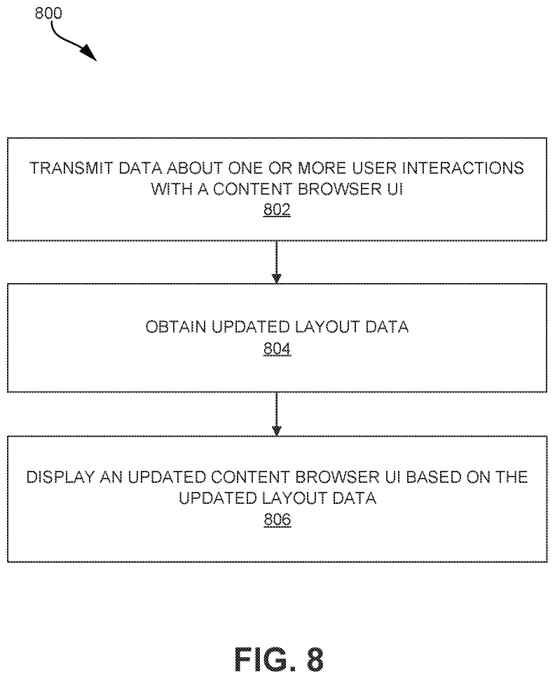

FIG. 8 is a flowchart illustrating another example method 800 for generating customized/personalized content browser UIs and browsing experiences. Method 800 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 8, as will be understood by a person of ordinary skill in the art.

Method 800 shall be described with reference to FIG. 3, FIG. 4, FIG. 5, FIG. 6 and/or FIG. 7. However, method 800 is not limited to that example. Referring to FIG. 8, at step 802, media device 106 may transmit data about one or more user interactions with a content browser user interface (UI) to a first computing system. In some examples, media device 106 may transmit data about one or more user interactions with a content browser UI, such as data 320, to system server(s) 126. Additionally, system server(s) 126 may provide data 322 to recommendation system 310. In some instances, data 322 may include portions of data associated with interactions between user 132 and the content browser UI as a whole, and portions of data associated with interactions between user 132 and one or more groups of tiles included in the content browser UI.

Additionally, at step 804, media device 106 may obtain updated interface data 330 from the first computing system. Moreover, at step 806, media device 106 may display an updated content browser UI based on updated interface data 330. In some examples, the first computing system, such as recommendation system 310, may generate or determine a first template, such as a UI template, and/or a second template, such as a group template based on the data about one or more user interactions with a content browser UI, such as data 322. In some cases, the first template may specify a layout of the content browser UI and the second template may specify a configuration of one or more groups of tiles of a plurality of groups of tiles. In some instances, the data used by group template engine 303 to determine/generate the second template and/or the associated group of tiles may include data about one or more user interactions with a content browser UI, group context information, group content related information, affinity information, device information, engagement information, account information, and/or search information. In some aspects, recommendation system 310, such as layout engine 305, may perform operations that cause the updating of the content browser UI.

For instance, layout engine 305 may generate updated interface data 330 that includes the determined or generated UI template and/or group templates. In such instances, layout engine 305 may provide updated interface data 330 to media device 106. Additionally, media device 106 may apply the UI template and/or group templates included in updated interface data 330 to the content browser UI.

In another instance, layout engine 305 may apply the UI template and/or group templates to a content browser UI. Additionally, layout engine 305 may generate updated interface data 330 that includes data characterizing the content browser UI with the applied UI template and/or group templates. In such instances, layout engine 305 may provide updated interface data 330 to media device 106. Additionally, media device 106 may present or display the content browser UI in accordance with updated interface data 330.

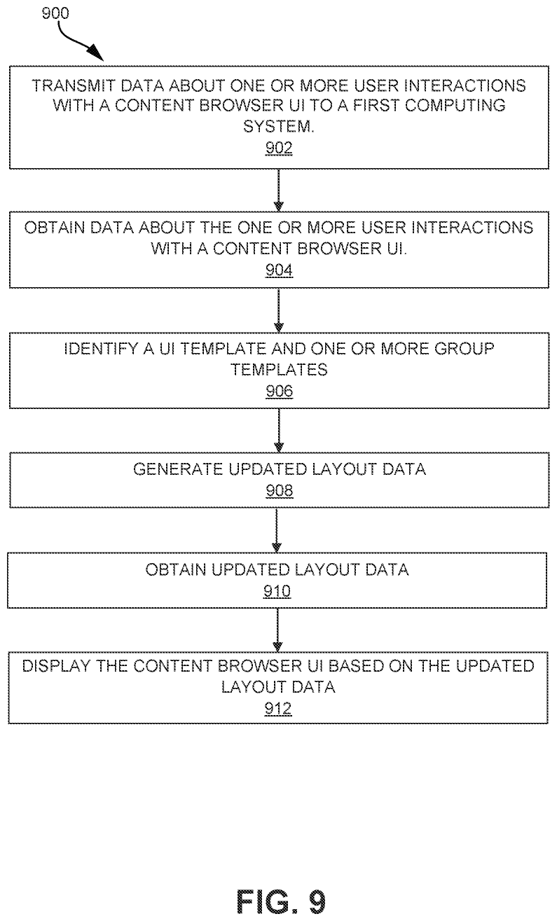

FIG. 9 is a flowchart illustrating another example method 900 for generating customized/personalized content browser UIs and browsing experiences. Method 900 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 9, as will be understood by a person of ordinary skill in the art.

Method 900 shall be described with reference to FIG. 3, FIG. 4, FIG. 5, FIG. 6 and/or FIG. 7. However, method 900 is not limited to that example. Referring to FIG. 9, at step 902, media device 106 may transmit data about one or more user interactions with a content browser user interface (UI) to a first computing system. In some examples, media device 106 may transmit data about one or more user interactions with a content browser UI, such as data 320, to a first computing system, such as recommendation system 310, via a second computing system, such as server systems(s) 126. In such examples server system(s) 126 may generate data 322 based on data 320 and provide data 322 to the first computing system. In some instances, data 322 may include portions of data associated with interactions between user 132 and the content browser UI as a whole, and portions of data associated with interactions between user 132 and one or more groups of tiles included in the content browser UI.

Additionally, at step 904, UI engine 302 may obtain data about one or more user interactions with a content browser user interface (UI). Moreover, at step 906, UI engine 302 may identify a UI template specifying a layout of the content browser UI and one or more group templates specifying a configuration of one or more groups of tiles of a plurality of groups of tiles of content browser UI. In some examples, UI engine 302 may include group template engine 303. In such examples, group template engine 303 may use portions of data 322 to determine or generate group templates for one or more of the group of tiles of content browser UI. In some instances, group template engine 303 may use portions of data 322 to identify the one or more groups of tiles.

In some examples, UI engine 302 may include UI template engine 304. In such examples, UI template engine 304 may use portions of data 322 to determine or generate the UI template.

Further, at step 908, UI engine 302 may generate updated interface data 330. In some examples, layout engine 305 of UI engine 302 may perform any of the example processes described herein to update the content browser UI. In some instances, layout engine 305 may generate updated interface data 330 that includes the determined or generated UI template and/or group templates. In other instances, layout engine 305 may apply the UI template and/or group templates to a content browser UI. Additionally, layout engine 305 may generate updated interface data 330 that includes data characterizing the content browser UI with the applied UI template and/or group templates.

In some cases, media device 106 may obtain updated interface data 330 from the first computing system (e.g., step 910 of method 900). Additionally, media device 106 may display a content browser UI based on updated interface data 330 (e.g., step 912 of method 900). In some examples, media device 106 may obtain updated interface data 330 including the UI template and/or group templates. In such examples, media device 106 may apply the UI template and/or group templates included in updated interface data 330 to the content browser UI. In other examples, media device 106 may obtain updated interface data 330 including data characterizing the content browser UI with the applied UI template and/or group templates. In such examples, media device 106 may present or display the content browser UI in accordance with updated interface data 330.

### Example Neural Network Architectures

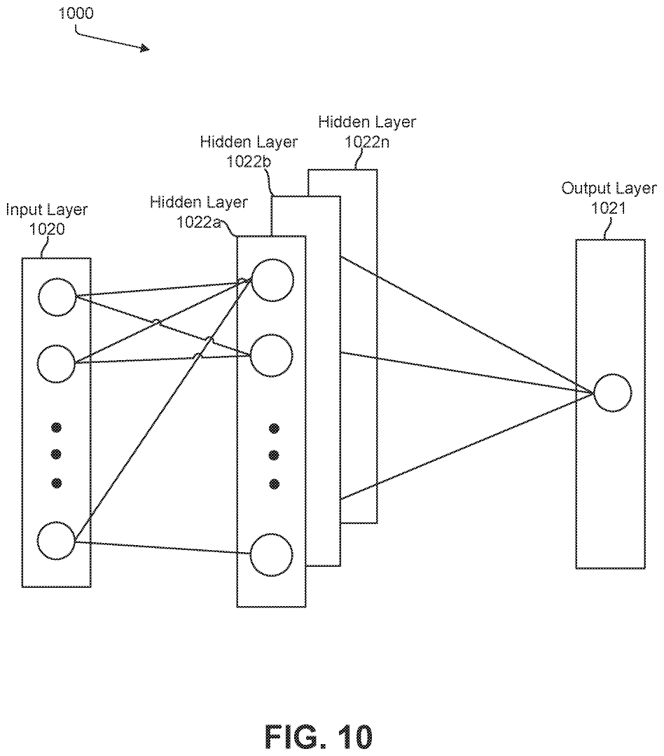

FIG. 10 is a diagram illustrating an example of a neural network architecture 1000 that can be used to implement some or all of the neural networks described herein. The neural network architecture 1000 can include an input layer 1020 that can be configured to receive and process data to generate one or more outputs. The neural network architecture 1000 also includes hidden layers 1022a, 1022b, through 1022n. The hidden layers 1022a, 1022b, through 1022n include “n” number of hidden layers, where “n” is an integer greater than or equal to one. The number of hidden layers can be made to include as many layers as needed for the given application. The neural network architecture 1000 further includes an output layer 1021 that provides an output resulting from the processing performed by the hidden layers 1022a, 1022b, through 1022n.

The neural network architecture 1000 is a multi-layer neural network of interconnected nodes. Each node can represent a piece of information. Information associated with the nodes is shared among the different layers and each layer retains information as information is processed. In some cases, the neural network architecture 1000 can include a feed-forward network, in which case there are no feedback connections where outputs of the network are fed back into itself. In some cases, the neural network architecture 1000 can include a recurrent neural network, which can have loops that allow information to be carried across nodes while reading in input.

Information can be exchanged between nodes through node-to-node interconnections between the various layers. Nodes of the input layer 1020 can activate a set of nodes in the first hidden layer 1022a. For example, as shown, each of the input nodes of the input layer 1020 is connected to each of the nodes of the first hidden layer 1022a. The nodes of the first hidden layer 1022a can transform the information of each input node by applying activation functions to the input node information. The information derived from the transformation can then be passed to and can activate the nodes of the next hidden layer 1022b, which can perform their own designated functions. Example functions include convolutional, up-sampling, data transformation, and/or any other suitable functions. The output of the hidden layer 1022b can then activate nodes of the next hidden layer, and so on. The output of the last hidden layer 1022n can activate one or more nodes of the output layer 1021, at which an output is provided. In some cases, while nodes in the neural network architecture 1000 are shown as having multiple output lines, a node can have a single output and all lines shown as being output from a node represent the same output value.

In some cases, each node or interconnection between nodes can have a weight that is a set of parameters derived from the training of the neural network architecture 1000. Once the neural network architecture 1000 is trained, it can be referred to as a trained neural network, which can be used to generate one or more outputs. For example, an interconnection between nodes can represent a piece of information learned about the interconnected nodes. The interconnection can have a tunable numeric weight that can be tuned (e.g., based on a training dataset), allowing the neural network architecture 1000 to be adaptive to inputs and able to learn as more and more data is processed.

The neural network architecture 1000 is pre-trained to process the features from the data in the input layer 1020 using the different hidden layers 1022a, 1022b, through 1022n in order to provide the output through the output layer 1021.

In some cases, the neural network architecture 1000 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network architecture 1000 is trained well enough so that the weights of the layers are accurately tuned.

To perform training, a loss function can be used to analyze an error in the output. Any suitable loss function definition can be used, such as a Cross-Entropy loss. Another example of a loss function includes the mean squared error (MSE), defined as E_total=≥Σ(½(target−output)\hat{ }2). The loss can be set to be equal to the value of E_total.

The loss (or error) will be high for the initial training data since the actual values will be much different than the predicted output. The goal of training is to minimize the amount of loss so that the predicted output is the same as the training output. The neural network architecture 1000 can perform a backward pass by determining which inputs (weights) most contributed to the loss of the network and can adjust the weights so that the loss decreases and is eventually minimized.

The neural network architecture 1000 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network architecture 1000 can include any other deep network other than a CNN, such as an autoencoder, Deep Belief Nets (DBNs), Recurrent Neural Networks (RNNs), among others.

As understood by those of skill in the art, machine-learning based techniques can vary depending on the desired implementation. For example, machine-learning schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

### Example Computer System

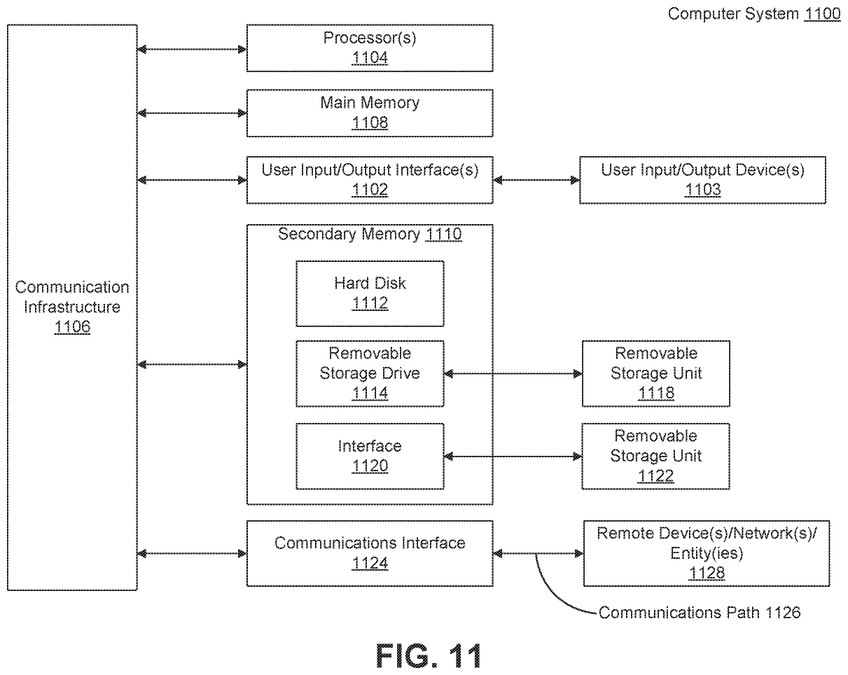

Various aspects and examples may be implemented, for example, using one or more well-known computer systems, such as computer system 1100 shown in FIG. 11. For example, the media device 106 may be implemented using combinations or sub-combinations of computer system 1100. Also, or alternatively, one or more computer systems 1100 may be used, for example, to implement any of the aspects and examples discussed herein, as well as combinations and sub-combinations thereof.

Computer system 1100 may include one or more processors (also called central processing units, or CPUs), such as a processor 1104. Processor 1104 may be connected to a communication infrastructure or bus 1106.

Computer system 1100 may also include user input/output device(s) 1103, such as monitors, keyboards, pointing devices, etc., which may communicate with communication infrastructure 1106 through user input/output interface(s) 1102.

One or more of processors 1104 may be a graphics processing unit (GPU). In some examples, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 1100 may also include a main or primary memory 1108, such as random access memory (RAM). Main memory 1108 may include one or more levels of cache. Main memory 1108 may have stored therein control logic (e.g., computer software) and/or data.

Computer system 1100 may also include one or more secondary storage devices or memory 1110. Secondary memory 1110 may include, for example, a hard disk drive 1112 and/or a removable storage device or drive 1114. Removable storage drive 1114 may be a floppy disk drive, a magnetic tape drive, a compact disk drive, an optical storage device, tape backup device, and/or any other storage device/drive.

Removable storage drive 1114 may interact with a removable storage unit 1118. Removable storage unit 1118 may include a computer usable or readable storage device having stored thereon computer software (control logic) and/or data. Removable storage unit 1118 may be a floppy disk, magnetic tape, compact disk, DVD, optical storage disk, and/any other computer data storage device. Removable storage drive 1114 may read from and/or write to removable storage unit 1118.

Secondary memory 1110 may include other means, devices, components, instrumentalities or other approaches for allowing computer programs and/or other instructions and/or data to be accessed by computer system 1100. Such means, devices, components, instrumentalities or other approaches may include, for example, a removable storage unit 1122 and an interface 1120. Examples of the removable storage unit 1122 and the interface 1120 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 1100 may include a communication or network interface 1124. Communication interface 1124 may enable computer system 1100 to communicate and interact with any combination of external devices, external networks, external entities, etc. (individually and collectively referenced by reference number 1128). For example, communication interface 1124 may allow computer system 1100 to communicate with external or remote devices 1128 over communications path 1126, which may be wired and/or wireless (or a combination thereof), and which may include any combination of LANs, WANs, the Internet, etc. Control logic and/or data may be transmitted to and from computer system 1100 via communication path 1126.

Computer system 1100 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 1100 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 1100 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some examples, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 1100, main memory 1108, secondary memory 1110, and removable storage units 1118 and 1122, as well as tangible articles of manufacture embodying any combination of the foregoing. Such control logic, when executed by one or more data processing devices (such as computer system 1100 or processor(s) 1104), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 11. In particular, embodiments can operate with software, hardware, and/or operating system implementations other than those described herein.

### CONCLUSION

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still cooperate or interact with each other.

The breadth and scope of this disclosure should not be limited by any of the above-described exemplary embodiments but should be defined only in accordance with the following claims and their equivalents.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:

Aspect 1. A computing system comprising: a memory storing instructions; and at least one processor coupled to the memory, the at least one processor being configured to execute the instructions to: obtain data about one or more user interactions with a content browser user interface (UI), wherein the content browser UI displays a plurality of groups of tiles representing different content items; identify, based on the data about the one or more user interactions, a first template specifying a layout of the content browser UI and a second template specifying a configuration of one or more groups of tiles of the plurality of groups of tiles; and update the content browser UI based on the second template.

Aspect 2. The computing system of Aspect 1, wherein the at least one processor is configured to execute the instructions further to: obtain additional data about the one or more user interactions with the content browser UI; update the first template based on the additional data about the one or more user interactions; and update of the content browser UI based on the updated first template.

Aspect 3. The computing system of any of Aspects 1 to 2, wherein the first template indicates at least one of a number of groups of tiles to include in a page of the content browser UI, a group type of each of the number of groups of tiles, a number of tiles to include each of the number of groups of tiles, and a layout of each of the number of groups.

Aspect 4. The computing system of Aspect 3, wherein the layout may include at least one of a row layout and a column layout.

Aspect 5. The computing system of any of Aspects 3 to 4, wherein the group type is associated with at least one of a genre, an application, and a media type.

Aspect 6. The computing system of any of Aspects 1 to 5, wherein the at least one processor is configured to execute the instructions further to: obtain metric data associated with the content browser UI, wherein identifying the first, and wherein identifying the first template and the second template is further based on the metric data.

Aspect 7. The computing system of any of Aspects 1 to 6, wherein the data about the one or more user interactions includes at least one of engagement data, device data, account data, content affinity data, platform affinity data, genre affinity data, context data and interface data.

Aspect 8. The computing system of any of Aspects 1 to 7, wherein the configuration specified in the second template comprises at least one of an aspect ratio of the one or more groups of tiles, a size of the one or more groups of tiles, and one or more display attributes of the one or more groups of tiles.

Aspect 9. The computing system of any of Aspects 1 to 8, wherein to identify the first template and the second template, the at least one processor is configured to execute the instructions to: apply one or more machine learning processes to the data about the one or more user interactions, wherein identifying the first template and the second template is based on the application of the one or more machine learning processes to the data about the one or more user interactions.

Aspect 10. A computer-implemented method comprising: obtaining data about one or more user interactions with a content browser user interface (UI), wherein the content browser UI displays a plurality of groups of tiles representing different content items; identifying, based on the data about the one or more user interactions, a first template specifying a layout of the content browser UI and a second template specifying a configuration of one or more groups of tiles of the plurality of groups of tiles; and updating the content browser UI based on the second template.

Aspect 11. The computer-implemented method of Aspect 10, further comprising: obtaining additional data about the one or more user interactions with the content browser UI; updating the first template based on the additional data about the one or more user interactions; and updating of the content browser UI based on the updated first template.

Aspect 12. The computer-implemented method of any of Aspects 10 to 11, wherein the first template indicates at least one of a number of groups of tiles to include in a page of the content browser UI, a group type of each of the number of groups of tiles, a number of tiles to include each of the number of groups of tiles, and a layout of each of the number of groups.

Aspect 13. The computer-implemented method of Aspect 12, wherein the layout may include at least one of a row layout and a column layout.

Aspect 14. The computer-implemented method of any of Aspects 12 to 13, wherein the group type is associated with at least one of a genre, an application, and a media type.

Aspect 15. The computer-implemented method of any of Aspects 10 to 14, further comprising: obtain metric data associated with the content browser UI, wherein identifying the first, wherein identifying the first template and the second template is further based on the metric data.

Aspect 16. The computer-implemented method of any of Aspects 10 to 15, wherein the data about the one or more user interactions includes at least one of user engagement data, device data, account data, content affinity data, platform affinity data, genre affinity data, context data and interface data.

Aspect 17. The computer-implemented method of any of Aspects 10 to 16, wherein the configuration specified in the second template comprises at least one of an aspect ratio of the one or more groups of tiles, a size of the one or more groups of tiles, and one or more display attributes of the one or more groups of tiles.

Aspect 18. The computer-implemented method of any of Aspects 10 to 17, wherein identifying the first template and the second template includes: applying one or more machine learning processes to the data about the one or more user interactions, wherein identifying the first template and the second template is based on the application of the one or more machine learning processes to the data about the one or more user interactions.

Aspect 19. A non-transitory computer-readable medium having instructions stored thereon that, when executed by at least one computing device, cause the at least one computing device to perform operations comprising: obtaining data about one or more user interactions with a content browser user interface (UI), wherein the content browser UI displays a plurality of groups of tiles representing different content items; identifying, based on the data about the one or more user interactions, a first template specifying a layout of the content browser UI and a second template specifying a configuration of one or more groups of tiles of the plurality of groups of tiles; and updating the content browser UI based on the second template.

Aspect 20. The non-transitory computer-readable medium of Aspect 19, wherein the at least one computing device further performs operations comprising: obtaining additional data about the one or more user interactions with the content browser UI; updating the first template based on the additional data about the one or more user interactions; and updating of the content browser UI based on the updated first template.

What is claimed is:

1. A computing system comprising:
a memory storing instructions; and
at least one processor coupled to the memory, the at least one processor being configured to execute the instructions to:
obtain data about one or more user interactions with a content browser user interface (UI), wherein the content browser UI displays a plurality of groups of tiles representing different content items;
identify, based on the data about the one or more user interactions, a first template specifying a layout of the content browser UI and a second template specifying a configuration of one or more groups of tiles of the plurality of groups of tiles; and
update the content browser UI based on the second template.

2. The computing system of claim 1, wherein the at least one processor is configured to execute the instructions further to:
obtain additional data about the one or more user interactions with the content browser UI;
update the first template based on the additional data about the one or more user interactions; and
update of the content browser UI based on the updated first template.

3. The computing system of claim 1, wherein the first template indicates at least one of a number of groups of tiles to include in a page of the content browser UI, a group type of each of the number of groups of tiles, a number of tiles to include each of the number of groups of tiles, and a layout of each of the number of groups.

4. The computing system of claim 3, wherein the layout may include at least one of a row layout and a column layout.

5. The computing system of claim 3, wherein the group type is associated with at least one of a genre, an application, and a media type.

6. The computing system of claim 1, wherein the at least one processor is configured to execute the instructions further to:
obtain metric data associated with the content browser UI, wherein identifying the first, and wherein identifying the first template and the second template is further based on the metric data.

7. The computing system of claim 1, wherein the data about the one or more user interactions includes at least one of engagement data, device data, account data, content affinity data, platform affinity data, genre affinity data, context data and interface data.

8. The computing system of claim 1, wherein the configuration specified in the second template comprises at least one of an aspect ratio of the one or more groups of tiles, a size of the one or more groups of tiles, and one or more display attributes of the one or more groups of tiles.

9. The computing system of claim 1, wherein to identify the first template and the second template, the at least one processor is configured to execute the instructions to:
apply one or more machine learning processes to the data about the one or more user interactions, wherein identifying the first template and the second template is based on the application of the one or more machine learning processes to the data about the one or more user interactions.

10. A computer-implemented method comprising:
obtaining data about one or more user interactions with a content browser user interface (UI), wherein the content browser UI displays a plurality of groups of tiles representing different content items;
identifying, based on the data about the one or more user interactions, a first template specifying a layout of the content browser UI and a second template specifying a configuration of one or more groups of tiles of the plurality of groups of tiles; and
updating the content browser UI based on the second template.

11. The computer-implemented method of claim 10, further comprising:
obtaining additional data about the one or more user interactions with the content browser UI;
updating the first template based on the additional data about the one or more user interactions; and
updating of the content browser UI based on the updated first template.

12. The computer-implemented method of claim 10, wherein the first template indicates at least one of a number of groups of tiles to include in a page of the content browser UI, a group type of each of the number of groups of tiles, a number of tiles to include each of the number of groups of tiles, and a layout of each of the number of groups.

13. The computer-implemented method of claim 12, wherein the layout may include at least one of a row layout and a column layout.

14. The computer-implemented method of claim 12, wherein the group type is associated with at least one of a genre, an application, and a media type.

15. The computer-implemented method of claim 10, further comprising:
obtain metric data associated with the content browser UI, wherein identifying the first, wherein identifying the first template and the second template is further based on the metric data.

16. The computer-implemented method of claim 10, wherein the data about the one or more user interactions includes at least one of user engagement data, device data, account data, content affinity data, platform affinity data, genre affinity data, context data and interface data.

17. The computer-implemented method of claim 10, wherein the configuration specified in the second template comprises at least one of an aspect ratio of the one or more groups of tiles, a size of the one or more groups of tiles, and one or more display attributes of the one or more groups of tiles.

18. The computer-implemented method of claim 10, wherein identifying the first template and the second template includes:
applying one or more machine learning processes to the data about the one or more user interactions, wherein identifying the first template and the second template is based on the application of the one or more machine learning processes to the data about the one or more user interactions.

19. A non-transitory computer-readable medium having instructions stored thereon that, when executed by at least one computing device, cause the at least one computing device to perform operations comprising:
obtaining data about one or more user interactions with a content browser user interface (UI), wherein the content browser UI displays a plurality of groups of tiles representing different content items;
identifying, based on the data about the one or more user interactions, a first template specifying a layout of the content browser UI and a second template specifying a configuration of one or more groups of tiles of the plurality of groups of tiles; and
updating the content browser UI based on the second template.

20. The non-transitory computer-readable medium of claim 19, wherein the at least one computing device further performs operations comprising:
obtaining additional data about the one or more user interactions with the content browser UI;
updating the first template based on the additional data about the one or more user interactions; and
updating of the content browser UI based on the updated first template.
